(19) United States
(12) Patent Application Publication
(10) Pub. No.: US 2022/0180453 A1
(43) Pub. Date: Jun. 9, 2022

(54) INFORMATION PROCESSING APPARATUS, SERVER APPARATUS, INFORMATION PROCESSING METHOD, AND PROGRAM

(71) Applicant: NIPPON GAS CO., LTD., Tokyo (JP)

(72) Inventor: Shinji WADA, Tokyo (JP)

(21) Appl. No.: 17/599,479

(22) PCT Filed: Feb. 26, 2020
(86) PCT No.: PCT/JP2020/007675

§ 371 Date: Sep. 28, 2021

(30) Foreign Application Priority Data
Mar. 29, 2019 (JP) 2019-065427

(51) Int. Cl. G06Q 50/06; G06Q 30/02

(52) U.S. Cl. CPC G06Q 50/06; G06Q 30/0206; G06Q 30/0202

(57) ABSTRACT

Conventionally, it is impossible to automatically determine an LPG price. It is possible to determine an LPG price based on gas use information and climate information, using an information processing apparatus including: a gas information storage unit that stores two or more pieces of gas information that contain gas use information regarding two or more households; a climate information acceptance unit that accepts climate information that is associated with time information that specifies time; a price information acquisition unit that acquires price information that specifies a price of LPG per unit amount at the time specified by the time information, using the gas use information regarding two or more households and the climate information; and a price information output unit that outputs the price information acquired by the price information acquisition unit.

### TECHNICAL FIELD

The present invention relates to, for example, an information processing apparatus that at least temporarily determines an LPG price, using gas use information and climate information.

### BACKGROUND ART

There is a conventional electricity charge setting system that reduces the risk of fuel price fluctuations for electricity companies or the like while setting a uniform electricity charge for a consumer during a predetermined period (see Patent Document 1).

When generating electricity using crude oil for which there is a futures trading market and natural gas for which there is not a futures trading market, the electricity rate setting system calculates, as an influence parameter, the degree of influence of the actual unit price of crude oil on the unit price of electricity sold, from the degree of influence of the actual unit price of crude oil on the unit price of natural gas and the use ratio of both resources, calculates an estimated electricity charge unit price of electricity sold, based on the actual unit price of crude oil, futures unit price, and the influence parameter, and calculates the unit price of electricity for a consumer, based on the estimated electricity charge unit price and the amount of electricity that the consumer plans to use in the future. The electricity charge setting system calculates a hedge quantity of crude oil to avoid the risk of future fluctuations in the crude oil price and the natural gas price, based on the planned amount of electricity to be used and the influence parameter.

### CITATION LIST

Patent Document
Patent Document 1: JP 2003-6374A

### SUMMARY OF INVENTION

### Technical Problem

However, according to the conventional technology, it is not possible to automatically determine the LPG price.

### Solution to Problem

An information processing apparatus according to a first aspect of the present invention is an information processing apparatus including: a gas information storage unit that stores two or more pieces of gas information that contain gas use information regarding two or more households; a climate information acceptance unit that accepts climate information that is associated with time information that specifies time; a price information acquisition unit that acquires price information that specifies a price of LPG per unit amount at the time specified by the time information, using the gas use information regarding two or more households and the climate information; and a price information output unit that outputs the price information acquired by the price information acquisition unit.

With such a configuration, it is possible to determine an LPG price, using gas use information and climate information.

An information processing apparatus according to a second aspect of the present invention is the information processing apparatus according to the first aspect of the invention, wherein the price information acquisition unit includes: a demand prediction part that acquires a predicted demand amount that is an amount of future demand for LPG, using gas use information regarding two or more households; and a price information acquisition part that acquires price information regarding each of one or more days, using the predicted demand amount acquired by the demand prediction parts and the climate information.

With such a configuration, it is possible to determine an LPG price, using gas use information and climate information.

An information processing apparatus according to a third aspect of the present invention is the information processing apparatus according to the first or second aspect of the invention, further including a related information storage unit that stores one or more pieces of related information of: gas price information regarding a gas price; exchange information regarding an exchange rate; and operation status information regarding an operation status of a gas tanker, and the price information acquisition unit acquires price information regarding one or more days that are ahead by a predetermined period, using the gas use information regarding two or more households, the climate information, and the one or more pieces of related information.

With such a configuration, it is possible to accurately determine an LPG price, using related information as well.

An information processing apparatus according to a fourth aspect of the present invention is the information processing apparatus according to the third aspect of the invention, wherein the price information acquisition unit acquires price information that indicates a higher price as a price that is specified by gas price information increases, or acquires price information that indicates a higher price when exchange information indicates a higher yen compared to when exchange information indicates a lower yen, or acquires price information that indicates a lower price when operation status information is information that indicates absence of a problem compared to when operation status information is information that indicates presence of any problem.

With such a configuration, it is possible to accurately determine an LPG price, using related information as well.

An information processing apparatus according to a fifth aspect of the present invention is the information processing apparatus according to any one of the first to fourth aspects of the invention, further including: a gas information reception unit that receives gas information from a gas information transmission apparatus that includes: a terminal acquisition unit that acquires gas information that is information that contains gas use information regarding use of gas in an LPG cylinder and corresponds to a customer identifier that identifies a customer; and a terminal transmission unit that transmits the gas information acquired by the terminal acquisition unit to the information processing apparatus; and a gas information accumulation unit that accumulates the gas information received by the gas information reception unit, in the gas information storage unit, in association with the customer identifier.

With such a configuration, it is easier to collect gas information regarding customers.

A server apparatus according to a sixth aspect of the present invention is the server apparatus according to any one of the first to fifth aspects of the invention, further including: a server storage unit that stores the price information output by the information processing apparatus; a server output unit that outputs the price information stored in the server storage unit; a server reception unit that receives a purchase instruction that is a purchase instruction that corresponds to the price information output by the server output unit, and contains a user identifier and amount information that specifies an amount; and a server processing unit that carries out futures trading processing through which a purchase reservation for the amount of LPG specified by the amount information at the price specified by the price information, according to the purchase instruction.

With this configuration, it is possible to carry out futures trading of gas, using gas use information and climate information.

A server apparatus according to a seventh aspect of the present invention is the server apparatus according to the sixth aspect of the invention, wherein the server processing unit includes: a futures trading part that carries out futures trading processing through which a purchase reservation for the amount of LPG specified by the amount information is made at the price specified by the price information stored in the server storage unit, according to the purchase instruction; a price changing part that, upon receiving the purchase instruction, acquires price information obtained by changing the price information stored in the server storage unit, and accumulates the price information in the server storage unit, and the server output unit outputs the price information changed by the price changing part.

With this configuration, it is possible to more appropriately carry out futures trading of gas, using gas use information and climate information.

### Advantageous Effects of Invention

With the information processing apparatus according to the present invention, it is possible to determine an LPG price, using gas use information and climate information.

### BRIEF DESCRIPTION OF DRAWINGS

FIG. 1 is a conceptual diagram for an information system A according to Embodiment 1.

FIG. 2 is a block diagram for the information system A according to the same.

FIG. 3 is a block diagram for an information processing apparatus A2 according to the same.

FIG. 4 is a flowchart illustrating examples of operations that are performed by a gas information transmission apparatus A1 according to the same.

FIG. 5 is a flowchart illustrating examples of operations that are performed by an information processing apparatus A2 according to the same.

FIG. 6 is a flowchart illustrating examples of operations that are performed by a next deliverer terminal A3 according to the same.

FIG. 7 is a flowchart illustrating examples of operations that are performed by a facility terminal A4 according to the same.

FIG. 8 is a conceptual diagram for the information system A according to the same.

FIG. 9 is a conceptual diagram for an information system D according to Embodiment 2.

FIG. 10 is a block diagram for the information system D according to the same.

FIG. 11 is a block diagram for an information processing apparatus D2 according to the same.

FIG. 12 is a flowchart illustrating examples of operations that are performed by a terminal apparatus D1 according to the same.

FIG. 13 is a flowchart illustrating an example of processing through which the information processing apparatus D2 according to the same determines price information.

FIG. 14 is a flowchart illustrating an example of price information acquisition processing according to the same.

FIG. 15 is a flowchart illustrating demand prediction processing according to the same.

FIG. 16 is a flowchart illustrating examples of operations that are performed by a server apparatus D3 according to the same.

FIG. 17 is an overview diagram for a computer system according to the above embodiments.

FIG. 18 is a block diagram for the computer system according to the same.

### DESCRIPTION OF EMBODIMENTS

The following describes embodiments of information system and so on with reference to the drawings. Note that the components with the same reference numerals in the embodiments perform the same operations, and therefore redundant descriptions thereof may be omitted.

### Embodiment 1

The present embodiment describes an information system that includes one or more gas information transmission apparatuses that acquire and transmit gas information that includes information regarding the use of gas in one or more LPG cylinders, and information processing apparatus.

In addition, the present embodiment describes an information system that includes a gas information transmission apparatus that transmits two or more pieces of gas information all at once. Note that the gas information transmission apparatus acquires gas use information described later, once an hour, and transmits the gas use information for one day, to the information processing apparatus, once a day, for example. Note that the gas information transmission apparatus may acquires the gas use information described later once an hour, and separately transmits the gas use information for one day, to the information processing apparatus, twice a day or more, for example.

Furthermore, the present embodiment describes an information system that includes an information processing apparatus that also receives delivery cylinder information described later, delivery vehicle position information described later, climate information described later, and cylinder replacement information described later.

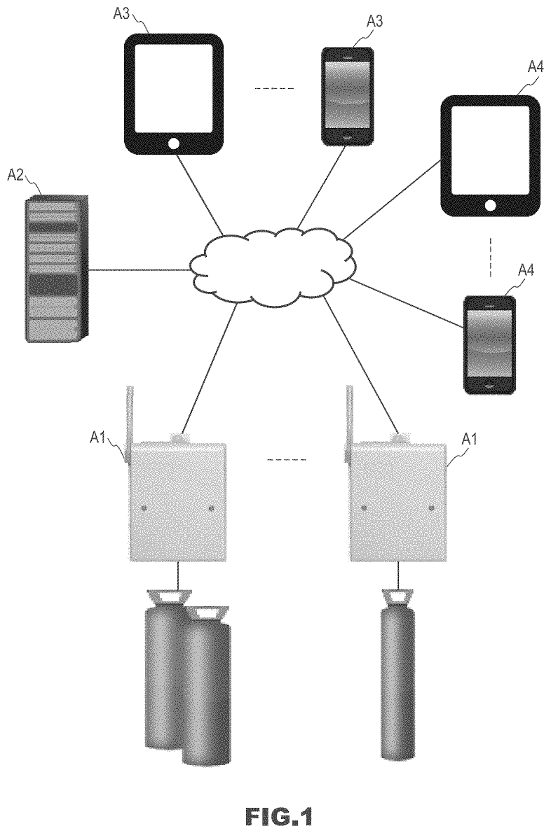

FIG. 1 is a conceptual diagram for an information system A according to the present embodiment. The information system A includes one or more gas information transmission apparatuses A1, an information processing apparatus A2, one or more deliverer terminals A3, and one or more facility terminals A4.

Gas information transmission apparatuses A1 are apparatuses that acquire gas information that includes gas use information, and transmit the gas information to the information processing apparatus A2. The gas information transmission apparatus A1 need only have a communication function, and the type thereof is not limited.

The information processing apparatus A2 is a server apparatus that receives and accumulates information such as gas information. “Information such as gas information” may be gas information alone, or one or more pieces of information of: delivery cylinder information described later; delivery vehicle position information described later; cylinder replacement information described later; and climate information may be used in addition to gas information. The information processing apparatus A2 can be realized using a so-called cloud server or an ASP server, but there is no limitation on the type thereof.

The deliverer terminals A3 are terminals that are used by deliverers. However, the deliverer terminals A3 may be terminals that are mounted on delivery vehicles. The deliverer terminals A3 are, for example, smartphones, tablet terminals, so-called personal computers, or the like, but there is no limitation on the type thereof. The deliverer terminals A3 have a communication function.

The facility terminals A4 are terminals that are present in the facility. The facility terminals A4 are, for example, smartphones, tablet terminals, so-called personal computers, or the like, but there is no limitation on the type thereof. The facility terminals A4 have a communication function. The facility is, for example, a factory or a depot station. A factory is a facility for filling gas cylinders with gas. A depot station is a facility where gas cylinders are placed.

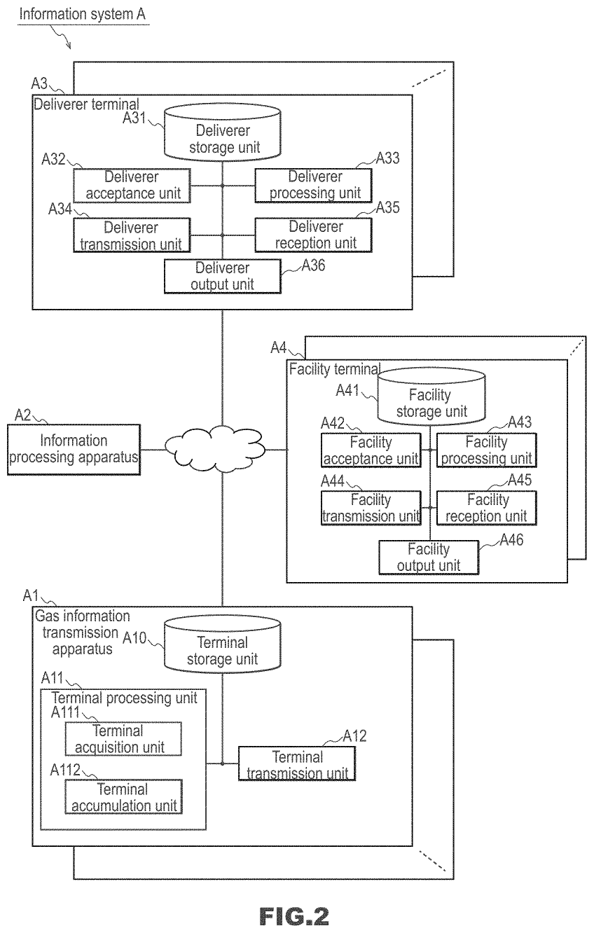

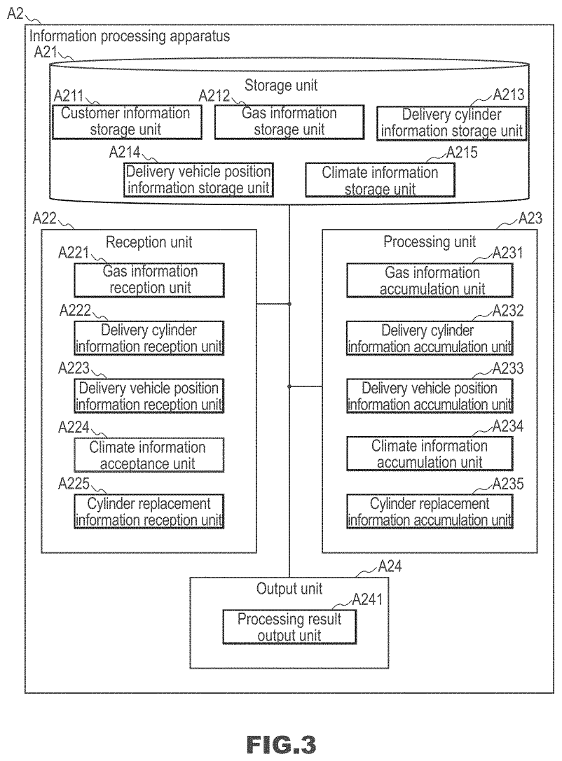

FIG. 2 is a block diagram for the information system A according to the present embodiment. FIG. 3 is a block diagram for the information processing apparatus A2 that is included in the information system A.

The gas information transmission apparatuses A1 includes a terminal storage unit A10, a terminal processing unit A11, and a terminal transmission unit A12. The terminal processing unit A11 includes a terminal acquisition unit A111 and a terminal accumulation unit A112.

The information processing apparatus A2 includes a storage unit A21, a reception unit A22, a processing unit A23, and an output unit A24. The storage unit A21 includes a customer information storage unit A211, a gas information storage unit A212, a delivery cylinder information storage unit A213, a delivery vehicle position information storage unit A214, and a climate information storage unit A215. The reception unit A22 includes a gas information reception unit A221, a delivery cylinder information reception unit A222, a delivery vehicle position information reception unit A223, a climate information acceptance unit A224, and a cylinder replacement information reception unit A225. The processing unit A23 includes a gas information accumulation unit A231, a delivery cylinder information accumulation unit A232, a delivery vehicle position information accumulation unit A233, a climate information accumulation unit A234, and a cylinder replacement information accumulation unit A235. The output unit A24 includes a processing result output unit A241.

Each deliverer terminal A3 includes a deliverer storage unit A31, a deliverer acceptance unit A32, a deliverer processing unit A33, a deliverer transmission unit A34, a deliverer reception unit A35, and a deliverer output unit A36.

Each facility terminal A4 includes a facility storage unit A41, a facility acceptance unit A42, a facility processing unit A43, a facility transmission unit A44, a facility reception unit A45, and a facility output unit A46.

The terminal storage unit A10 included in each gas information transmission apparatus A1 stores various kinds of information. Examples of the various kinds of information include gas information, a customer identifier that identifies a customer, a cylinder identifier that identifies a cylinder, and time information that specifies a time. Time information is, for example, date information that specifies a date, time point information that specifies a date and time, and time zone information that specifies a time zone. When time information is time point information, the time information may be regarded as including date information.

The terminal storage unit A10 stores pieces of gas information as of two or more points in time. Gas information is, for example, information associated with a cylinder identifier, a customer identifier that identifies a customer, and date information that indicates a date. Gas information is associated with time information, for example. Gas information contains, for example, gas use information. Gas use information is information regarding the gas used. Gas information contains, for example, one or more pieces of information of: unit time gas use information; and gas meter reading value information. Unit time gas use information is information that specifies the amount of gas used per unit time. Unit time gas use information is, for example, information that specifies the amount of gas used every one hour. Gas meter reading value information is, for example, information that specifies a gas meter reading value. Gas meter reading value information is, for example, information that specifies gas meter reading values acquired every one hour.

The gas information in the terminal storage unit A10 typically is information accumulated by the terminal accumulation unit A112.

The terminal processing unit A11 performs various kinds of processing. Examples of the various kinds of processing include processing that is performed by the terminal acquisition unit A111 and the terminal accumulation unit A112. Examples of the various kinds of processing include processing that is performed to delete gas information that has been transmitted, from the terminal storage unit A10.

The terminal acquisition unit A111 acquires gas information that is information that includes gas use information regarding the use of gas in an LPG cylinder and corresponds to a cylinder identifier that identifies an LPG cylinder. The terminal acquisition unit A111 acquires, for example, information from a gas meter. The terminal acquisition unit A111 acquires, for example, a meter reading value acquired from a gas meter, and calculates a gas use information that is the difference between the previous meter reading value and the current meter reading value and specifies the amount of gas used per unit time.

It is preferable that the terminal acquisition unit A111 acquires gas use information n times a day (n is 2 or more) every unit time. It is also preferable that the terminal acquisition unit A111 acquires gas use information every one hour.

It is preferable that the terminal acquisition unit A111 acquires time information from a clock (not shown) and associates the time information with the acquired gas use information. Note that the clock (not shown) may be present in the gas information transmission apparatuses A1 or may be a clock of an external apparatus such as an NTP server.

The terminal accumulation unit A112 accumulates the gas information acquired by the terminal acquisition unit A111, in the terminal storage unit A10. It is preferable that the terminal accumulation unit A112 accumulates the gas information acquired by the terminal acquisition unit A111, in the terminal storage unit A10 every unit time. Note that the unit time is, for example, on hour, thirty minutes, two hours, or the like. It is also preferable that the terminal accumulation unit A112 accumulates the gas information acquired by the terminal acquisition unit A111, in the terminal storage unit A10 in association with one or more pieces of information of: a customer identifier, a cylinder identifier, and time information.

The terminal transmission unit A12 transmits the gas information acquired by the terminal acquisition unit A111 to the information processing apparatus A2. The gas information acquired by the terminal acquisition unit A111 may be the gas information stored in the terminal storage unit A10.

The terminal transmission unit A12 transmits, for example, the gas information acquired by the terminal acquisition unit A111 to the information processing apparatus A2 in association with one or more identifiers. The one or more identifiers are, for example, one or more identifiers of: a cylinder identifier; and a cylinder identifier.

It is preferable that the terminal transmission unit A12 transmits gas information as of two or more time points stored in the terminal storage unit A10 to the information processing apparatus A2 when a predetermined condition is satisfied. The predetermined condition is, for example, that a predetermined time is reached, a predetermined number of pieces of gas information are stored in the terminal storage unit A10, or the like. In addition, transmitting gas information in association with a cylinder identifier or the like is, for example, transmitting gas information together with a cylinder identifier or the like, but there is no limitation on the method of associating pieces of information with each other. Note that the cylinder identifier is normally stored in the terminal storage unit A10. It is also preferable that, when the cylinder to be used is changed to another cylinder, the cylinder identifier of the other cylinder is automatically stored in the terminal storage unit A10.

Here, the transmission of gas information as of two or more time points may mean the transmission of two or more information sets that each consists of a piece of gas information and a piece of time information, or the transmission of two or more pieces of gas information arranged in chronological order.

In addition, the transmission of gas information for one day may mean the transmission of twenty-four information sets that each consists of gas information and time information, or the transmission of twenty-four pieces of gas information arranged in chronological.

Note that one piece of gas information is information that contains one piece of gas use information, but one piece of gas information may be information that contains a plurality of pieces of gas use information.

It is preferable that the terminal transmission unit A12 transmits two or more pieces of gas information in the terminal storage unit A10 to the information processing apparatus A2 less than n times a day.

It is preferable that the terminal transmission unit A12 transmits gas information to the information processing apparatus A2 once a day. Note that there is no limitation on the time at which the terminal transmission unit A12 transmits gas information.

The terminal transmission unit A12 may transmit gas information at different time points depending on a condition. That is, for example, the terminal transmission unit A12 may normally transmit a plurality of pieces of gas information to the information processing apparatus A2 at a low frequency (a first frequency), and when a predetermined condition is satisfied, the terminal transmission unit A12 may transmit gas information to the information processing apparatus A2 at a higher frequency (a second frequency) than the frequency in the normal case. The predetermined condition here is, for example, that the terminal processing unit A11 determines that the amount of gas that has been used is large enough to satisfy the predetermined condition (for example, an amount of gas no less than or greater than a threshold value has been used). Alternatively, the predetermined condition is, for example, that the terminal processing unit A11 determines that a small amount of gas has been used for a period that is long enough to satisfy the predetermined condition (for example, an amount of gas no greater than or less than a threshold value has been used for a period no less than a first threshold value).

It is also preferable that, after the terminal transmission unit A12 has transmitted gas information to the information processing apparatus A2, the terminal processing unit A11 deletes the transmitted gas information from the terminal storage unit A10.

The storage unit A21 included in the information processing apparatus A2 stores various kinds of information. Examples of the various kinds of information include customer information described later, gas information, delivery cylinder information described later, delivery vehicle position information described later, and climate information described later.

The customer information storage unit A211 stores one or more pieces of customer information each in association with a customer identifier. Customer information is information regarding a customer. Customer information contains, for example, a name, customer position information, and contact information. Customer position information is information that specifies the position of a customer. Customer position information is, for example, (latitude, longitude), address, or the like. Contact information is information that specifies a point of contact, and is, for example, an e-mail address or a telephone number. date information contains, for example, date information that specifies the date on which the gas cylinder was replaced. The customer information contains, for example, cylinder type information, cylinder number information, and gas remaining amount information. Cylinder type information is information that specifies the type of the cylinder used by the customer. The cylinder number information is information that specifies the number of cylinders installed in the customer's home. Gas remaining amount information is information that specifies the amount of gas remaining in the customer's gas cylinders. Customer information contains, for example, one or more medium identifiers that identify the medium used by the customer (for example, “LPG” and “electricity”), one or more appliance identifiers of energy appliances owned by the customer (for example, “gas appliance A”, “electric appliance B”, and “appliance C”), and one or more company identifiers that identify the energy companies with which the customer has a contract (for example, “company A”). Customer information may contain, for example, LPG cylinder information that contains cylinder capacity information regarding the capacity of the LPG cylinder used by the customer. Note that LPG cylinder information may be cylinder type information.

The gas information storage unit A212 stores one or more pieces of gas information. The gas information storage unit A212 normally stores two or more pieces of gas information associated with customer identifiers. It is preferable that the pieces of gas information are associated with one or more pieces of information of: time information that specifies a time; and a cylinder identifier. In addition, here, the association with time information and cylinder identifier may be realized by storing gas information so that time information and a cylinder identifier can be known.

The delivery cylinder information storage unit A213 stores one or more pieces of delivery cylinder information. Delivery cylinder information is information regarding a cylinder that is to be delivered. Delivery cylinder information contains, for example, cylinder type information and cylinder state information. Delivery cylinder information typically is information from which the number of cylinders can be known. That is to say, delivery cylinder information may contain number information that specifies the number of cylinders, or the number of pieces of delivery cylinder information that have been received may indicate the number of cylinders. Cylinder type information is information that specifies the type of the cylinder, and indicates, for example, 20 Kg, 30 Kg, or 50 Kg. Cylinder state information is information that indicates whether or not the cylinder is full. Delivery cylinder information corresponds to, for example, one or more pieces of information of: a cylinder identifier; a delivery vehicle identifier; a deliverer identifier; and time information that specifies entry/exit date and time. Note that the entry/exit date and time is an entry date and time or an exit date and time to/from a factory where the cylinder is to be filled with gas, or entry date and time or an exit date and time to/from a depot station where cylinders are stored. Alternatively, time point information may be information that only specifies a date.

The delivery vehicle position information storage unit A214 stores one or more pieces of delivery vehicle position information. Delivery vehicle position information is information that specifies the position of a delivery vehicle. Delivery vehicle position information is, for example, (latitude, longitude), but may be, for example, a facility identifier that identifies the nearest facility. The facility is, for example, a factory or a depot station. Delivery vehicle position information is associated with, for example, a delivery vehicle identifier that identifies the delivery vehicle for the cylinder, or a deliverer identifier.

The climate information storage unit A215 stores one or more pieces of climate information. Climate information is information regarding weather. Climate information is, for example, one or more pieces of information of: weather; temperature; humidity; and so on. It is preferable that climate information is associated with time information. Time information is, for example, date information and time point information.

The reception unit A22 receives various kinds of information. Examples of the various kinds of information include gas information, delivery cylinder information, delivery vehicle position information, climate information, and cylinder replacement information.

The gas information reception unit A221 receives one or more pieces of gas information from the gas information transmission apparatuses A1. The gas information reception unit A221 receives, for example, gas information associated with one or more identifiers of: a customer identifier; and a cylinder identifier, from the gas information transmission apparatuses A1.

The delivery cylinder information reception unit A222 receives one or more pieces of delivery cylinder information. The delivery cylinder information reception unit A222 receives delivery cylinder information in association with one or more pieces of information of: a cylinder identifier; a delivery vehicle identifier; and a deliverer identifier, for example. The delivery cylinder information reception unit A222 receives delivery cylinder information in association with a loading platform identifier, for example. The loading platform identifier is information that specifies a loading platform loading platform on which the cylinder is placed. The delivery cylinder information reception unit A222 receives delivery cylinder information in association with time point information that identifies entry/exit date and time, for example. The entry/exit date and time is the date and time of entry/exit to/from a facility. The delivery cylinder information reception unit A222 receive delivery cylinder information from the facility terminals A4, for example. The delivery cylinder information reception unit A222 receive delivery cylinder information from the deliverer terminals A3, for example. Note that there is no limitation on the source of delivery cylinder information. The cylinder identifier is, for example, information stored in a communication means (for example, an RFID tag) installed in a cylinder that is to be delivered, and indirectly or directly received from such a communication means. The cylinder identifier may be, for example, information input to a facility terminal A4 by a user and transmitted from the facility terminal A4. The delivery vehicle identifier is, for example, information stored in a communication means (for example, an RFID tag) installed in a delivery vehicle itself (for example, a trailer head), and indirectly or directly received from such a communication means. Note that, in such a case, the delivery vehicle identifier may be referred to as a trailer head identifier. In addition, the delivery vehicle identifier and the trailer head identifier may be different pieces of information, and in such a case, the delivery cylinder information reception unit A222 may receive delivery cylinder information in association with the trailer head identifier. In addition, the deliverer identifier is, for example, information indirectly or directly received from a deliverer terminal A3 held by a deliverer. The deliverer identifier may be, for example, information stored in a communication means installed in a delivery vehicle itself (for example, a trailer head), and indirectly or directly received from such a communication means. Furthermore, the loading platform identifier is, for example, information stored in a communication means (for example, an RFID tag) installed in a loading platform of a delivery vehicle, and indirectly or directly received from such a communication means.

The delivery vehicle position information reception unit A223 receives one or more pieces of delivery vehicle position information. The delivery vehicle position information reception unit A223 normally receives delivery vehicle position information from the deliverer terminals A3 that are terminals on delivery vehicles, but there is no limitation on the source of delivery vehicle position information. Note that the deliverer terminals A3 may be terminals that are different from the terminals held by deliverers, and may be terminals mounted on delivery vehicles.

The delivery vehicle position information reception unit A223 normally receives delivery vehicle position information in association with a delivery vehicle identifier that identifies a delivery vehicle. However, the delivery vehicle position information reception unit A223 may receive delivery vehicle position information in association with a deliverer identifier. Also, delivery vehicle identifier and deliverer identifier may be the same information.

The climate information acceptance unit A224 receives one or more pieces of climate information. Here, “acceptance” means, for example, reception from a server apparatus (not shown), but may be regarded as a concept that includes acceptance of information input from an input device such as a keyboard, a mouse, or a touch panel, or acceptance of information read from a recording medium such as an optical disk, a magnetic disk, or a semiconductor memory. Note that the server apparatus (not shown) is an apparatus that stores climate information.

The cylinder replacement information reception unit A225 receives one or more pieces of cylinder replacement information. Cylinder replacement information is information that indicates that a cylinder has been replaced. The cylinder replacement information reception unit A225 receives cylinder replacement information that is paired with one or more pieces of information of: a customer identifier; and a cylinder identifier, for example. The cylinder replacement information reception unit A225 receives, for example, cylinder replacement information from a deliverer terminal A. Note that there is no limitation on the transmission source of cylinder replacement information.

The processing unit A23 performs predetermined processing, using two or more pieces of gas information stored in the gas information storage unit A212. Examples of the predetermined processing include delivery date prediction processing described later, delivery control processing described later, futures trading processing described later, residence stay processing described later, energy optimum plan presentation processing described later, household credit rating acquisition processing described later, statistical processing, and so on. statistical processing is statistical processing to be performed on a plurality of pieces of gas information. Examples of statistical processing includes processing that is performed to calculate the average amount of gas used by a household for a certain period from a plurality of pieces of gas information, processing that is performed to calculate the cumulative value of the amount of gas used for a certain period, and processing that is performed to acquire a graph showing changes in the amount of gas used. Note that delivery date prediction processing, delivery control processing, futures trading processing, residence stay processing, energy optimum plan presentation processing, and household credit rating acquisition processing will be described in Embodiment 2 and the subsequent embodiments. Note that delivery date prediction processing is processing that is performed to predict the delivery date on which a gas cylinder is to be delivered to household. Delivery control processing is processing that is performed to deliver a gas cylinder to a household that has run out of gas, for example. Futures trading processing is processing that is performed to determine the price of gas and supporting futures trading. Residence stay processing is processing that is performed to output information regarding whether or not an inhabitant is present in a residence. Energy optimum plan presentation processing is processing that is performed to present an appropriate energy plan. Household credit rating acquisition processing is processing that is performed to acquire and output a credit rating of a household.

The processing unit A23 performs predetermined processing, also using one or more pieces of delivery cylinder information stored in the delivery cylinder information storage unit A213, for example. The predetermined processing is, for example, delivery control processing.

The processing unit A23 performs the predetermined processing, using one or more pieces of delivery vehicle position information stored in the delivery vehicle position information storage unit A214, for example. The predetermined processing is, for example, delivery control processing.

The processing unit A23 performs the predetermined processing, using one or more pieces of climate information stored in the climate information storage unit A215. Examples of the predetermined processing include delivery date prediction processing, futures trading processing, and energy optimum plan presentation processing.

The gas information accumulation unit A231 accumulates the one or more pieces of gas information received by the gas information reception unit A221, in the gas information storage unit A212. The gas information accumulation unit A231 accumulates each piece of gas information received by the gas information reception unit A221, in the gas information storage unit A212, in association with one or more pieces of information of: time information; a customer identifier; and a cylinder identifier. Note that such time information may be information received from the gas information transmission apparatuses A1, or information acquired from a clock (not shown).

The delivery cylinder information accumulation unit A232 accumulates the one or more pieces of delivery cylinder information received by the delivery cylinder information reception unit A222, in the delivery cylinder information storage unit A213. The delivery cylinder information accumulation unit A232 accumulates each piece of delivery cylinder information in the delivery cylinder information storage unit A213 in association with one or more pieces of information of: a cylinder identifier; a delivery vehicle identifier; and a deliverer identifier, for example.

The delivery vehicle position information accumulation unit A233 accumulates the one or more pieces of delivery vehicle position information received by the delivery vehicle position information reception unit A223, in the delivery vehicle position information storage unit A214. The delivery vehicle position information accumulation unit A233 accumulates each piece of delivery vehicle position information in the delivery vehicle position information storage unit A214 in association with a delivery vehicle identifier or a deliverer identifier.

The climate information accumulation unit A234 accumulates one or more pieces of climate information, in the climate information storage unit A215. The climate information accumulation unit A234 normally each piece of climate information in the climate information storage unit A215 in association with time information. Note that time information may be information received by the reception unit A22 or may be acquired from a clock (not shown). In addition, time information may be date information or time point information.

When the cylinder replacement information reception unit A225 receives cylinder replacement information, the cylinder replacement information accumulation unit A235 updates the gas remaining amount information contained in the gas information paired with one or more pieces of information of: a customer identifier; and a cylinder identifier, to information that specifies that the amount of gas remaining is full.

The deliverer storage unit A31 included in each deliverer terminal A3 stores various kinds of information. Examples of the various kinds of information include a deliverer identifier that identifies a deliverer. Examples of the various kinds of information include a delivery vehicle identifier that identifies a delivery vehicle. The deliverer identifier and the delivery vehicle identifier may be the same information. Examples of the various kinds of information include cylinder replacement information. Cylinder replacement information is information that indicates that a cylinder has been replaced. Cylinder replacement information is associated with one or more identifiers of: a customer identifier; and a cylinder identifier.

The deliverer acceptance unit A32 accepts various instructions and various kinds of information. Examples of the various instructions and various kinds of information include cylinder replacement information. Examples of the various instructions and various kinds of information include cylinder replacement information and one or more identifiers of: a customer identifier; and a cylinder identifier. When a cylinder of a certain household is to be replaced or has been replaced, the deliverer inputs cylinder exchange information to the deliverer terminal A3. In addition, cylinder replacement information may be input by pressing a button, or may be input by inputting information in a field, for example.

It is preferable that the deliverer inputs one or more identifiers of: a customer identifier; and a cylinder identifier together with cylinder replacement information. In such a case, the deliverer acceptance unit A32 accepts cylinder replacement information, and one or more identifiers of: a customer identifier; and a cylinder identifier.

Any input means may be employed to input cylinder replacement information, such as a touch panel, a keyboard, a mouse, a menu screen, or the like. The deliverer acceptance unit A32 can be realized using a device driver for the input means such as a touch panel or a keyboard, or control software or the like for controlling the menu screen.

The deliverer processing unit A33 performs various kinds of processing. Examples of the various kinds of information include processing that is performed to convert the information accepted by the deliverer acceptance unit A32 so as to have a data structure of information to be transmitted. Examples of the various kinds of processing include processing that is performed when the deliverer acceptance unit A32 accepts cylinder replacement information, to form information in which the cylinder replacement information, the deliverer identifier in the deliverer storage unit A31, and one or more identifiers of: the customer identifier; and the cylinder identifier, which have been input, are associated with each other. Examples of the various kinds of information include processing that is performed to convert the information received by the deliverer reception unit A35 so as to have a data structure of information that is to be output.

The deliverer transmission unit A34 transmits cylinder replacement information to the information processing apparatus A2. The deliverer transmission unit A34 normally transmits cylinder replacement information that is associated with one or more identifiers of: a customer identifier; and a cylinder identifier, to the information processing apparatus A2. It is preferable that the deliverer transmission unit A34 transmits a deliverer identifier as well as cylinder replacement information.

The deliverer reception unit A35 receives various kinds of information. The deliverer reception unit A35 receives various kinds of information from the information processing apparatus A2, for example. The deliverer reception unit A35 receives customer information described later, from the information processing apparatus A2, for example. Note that customer information is information regarding a customer, and is information paired with a customer identifier. The customer information received by the deliverer reception unit A35 is information regarding the customer to which a gas cylinder is to be delivered, for example. Note that the customer identifier may be contained in customer information.

The deliverer output unit A36 outputs various kinds of information. Examples of the various kinds of information include information formed by the deliverer processing unit A33. Examples of the various kinds of information include customer information. Customer information is information regarding the customer to which a gas cylinder is to be delivered. It is preferable that customer information contains one or more pieces of information of: a customer identifier; customer position information; and information regarding the gas cylinder to be delivered. Customer position information is information that specifies the position of a customer. Customer position information is, for example, (latitude, longitude), address, or the like. Information regarding the gas cylinder to be delivered is, for example, cylinder type information that specifies the type of a gas cylinder, the number of gas cylinders, and so on.

Here, “output” typically means displaying on a display device, but may be regarded as a concept that includes projection with a projector, printing with a printer, sound output, transmission to an external apparatus, accumulation on a recording medium, delivery of processing results to another processing apparatus or another program, and so on.

The facility storage unit A41 included in each facility terminal A4 stores various kinds of information. Examples of the various kinds of information include a facility identifier that identifies a facility. It is preferable that the facility storage unit A41 stores delivery cylinder information that is information received by a terminal in a delivery vehicle, (for example, an RFID) and is information regarding a cylinder mounted on the delivery vehicle. Delivery cylinder information is associated with a cylinder identifier. It is preferable that delivery cylinder information is associated with a loading platform identifier and entry/exit date and time, for example. Delivery cylinder information contains, for example, cylinder type information and cylinder state information. It is preferable that delivery cylinder information contains information that specifies the number of cylinders to be delivered.

The facility acceptance unit A42 accepts various instructions and various kinds of information.

The facility processing unit A43 performs various kinds of processing. Examples of the various kinds of processing include processing that is performed to accumulate information received by the facility reception unit A45. The facility processing unit A43 at least temporarily accumulates the delivery cylinder information and identifiers received by the facility reception unit A45, in the facility storage unit A41. Note that examples of the identifiers include one or more identifiers of: a cylinder identifier; a loading platform identifier; a delivery vehicle identifier; and a deliverer identifier.

The facility transmission unit A44 transmits various kinds of information. The facility transmission unit A44 transmits, for example, various kinds of information to the information processing apparatus A2. The facility transmission unit A44 transmits delivery cylinder information in association with identifiers, for example. Examples of the identifiers include one or more identifiers of: a cylinder identifier; a loading platform identifier; a delivery vehicle identifier; and a deliverer identifier.

The facility reception unit A45 receives various kinds of information. The facility reception unit A45 receives, for example, various kinds of information from a terminal of a delivery vehicle (for example, an RFID). The facility reception unit A45 receives delivery cylinder information in association with identifiers, for example. Examples of the identifiers include one or more identifiers of: a cylinder identifier; a loading platform identifier; a delivery vehicle identifier; and a deliverer identifier.

The facility output unit A46 outputs various kinds of information.

It is preferable that the terminal storage unit A10, the storage unit A21, the customer information storage unit A211, the gas information storage unit A212, the delivery cylinder information storage unit A213, the delivery vehicle position information storage unit A214, the climate information storage unit A215, the deliverer storage unit A31, and the facility storage unit A41 are realized using a non-volatile recording medium, but they can be realized using a volatile recording medium.

There is no limitation on the process in which information is stored in the terminal storage unit A10 and so on. For example, information may be stored in the terminal storage unit A10 or the like via a recording medium, or information transmitted via a communication line or the like may be stored in the terminal storage unit A10 or the like, or information input via an input device may be stored in the terminal storage unit A10 or the like.

The terminal processing unit A11, the terminal acquisition unit A111, the terminal accumulation unit A112, the processing unit A23, the gas information accumulation unit A231, the delivery cylinder information accumulation unit A232, the delivery vehicle position information accumulation unit A233, the climate information accumulation unit A234, the cylinder replacement information accumulation unit A235, the deliverer processing unit A33, and the facility processing unit A43 can typically be realized using an MPU, a memory, or the like. The processing procedures performed by the terminal processing unit A11 and so on typically are realized using software, and the software is recorded on a recording medium such as a ROM. However, such processing procedures may be realized using hardware (a dedicated circuit). Needless to say, a CPU or a GPU may be used instead of the MPU.

The terminal transmission unit A12, the output unit A24, processing result output unit A241, the deliverer transmission unit A34, and the facility transmission unit A44 typically are realized using a wireless or wired communication means, but may be realized using a broadcast means.

The reception unit A22, the gas information reception unit A221, the delivery cylinder information reception unit A222, the delivery vehicle position information reception unit A223, the climate information acceptance unit A224, the cylinder replacement information reception unit A225, the deliverer reception unit A35, and the facility reception unit A45 typically are realized using a wireless or wired communication means, but may be realized using a means for receiving broadcast.

The deliverer acceptance unit A32 and the facility acceptance unit A42 can be realized using a touch panel, a keyboard, a mouse, a menu screen, or the like.

The deliverer output unit A36 and the facility output unit A46 may be regarded as including or not including an output device such as a display or a speaker. The deliverer output unit A36 and so on can be realized using the driver software of the output device, the driver software of the output device and the output device, or the like.

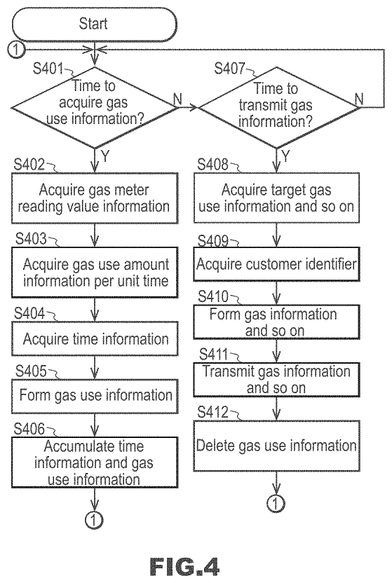

Next, operations that are performed by the information system A will be described. First, examples of operations that are performed by the gas information transmission apparatus A1 will be described with reference to the flowchart shown in FIG. 4.

(Step S401) The terminal processing unit A11 determines whether or not it is the time to acquire gas use information. If it is the time to acquire gas use information, processing proceeds to step S402, and if it is not the time to acquire gas use information, processing proceeds to step S407. For example, when acquiring gas use information every one hour, the terminal processing unit A11 acquires time information from a clock (not shown), and if the time indicated by the time information matches “X hour 00 minutes” (X is a natural number in the range of 1 to 24), the terminal processing unit A11 determines that it is the time to acquire gas use information.

(Step S402) The terminal acquisition unit A111 acquires gas meter reading value information from a gas meter (not shown). Noted that such a technique is a well-known technique. Note that the gas meter typically is an LP gas meter, and is a device that holds the gas meter reading value that indicates the flow rate integration measured from the installation of the device.

(Step S403) The terminal acquisition unit A111 calculates information indicating gas use amount per unit time, which is the difference between the previously acquired gas meter reading value information and the gas meter reading value information currently acquired in step S402. Note that the terminal acquisition unit A111 acquires the information indicating the gas use amount per unit time by calculating, for example, “information indicating the gas use amount per unit time=the previously acquired gas meter reading value information—the gas meter reading value information acquired in step S402”.

(Step S404) The terminal acquisition unit A111 acquires time information that indicates the current time from a clock (not shown).

(Step S405) The terminal acquisition unit A111 forms gas use information to be accumulated, using the information indicating the gas use amount per unit time, acquired in step S403.

(Step S406) The terminal accumulation unit A112 accumulates the time information acquired in step S404 and the gas use information formed in step S405 in association with each other. Processing returns to step S401. Note that the location where the gas use information or the like is to be accumulated typically is the terminal storage unit A10. Note that the terminal accumulation unit A112 may accumulate gas use information in association with a cylinder identifier. In such a case, the terminal acquisition unit A111 acquires the cylinder identifier as well.

(Step S407) The terminal processing unit A11 determines whether or not it is the time to transmit gas information. If it is the time to transmit gas information, processing proceeds to step S408, and if it is not the time to transmit gas information, processing returns to step S401. For example, when transmitting gas information once a day, the terminal processing unit A11 acquires time information from a clock (not shown), and upon determining that the time indicated by the time information has passed a predetermined time (for example, “24:01”), the terminal processing unit A11 determines that it is the time to transmit gas information. Note that even if it is determined that the predetermined time has passed, the gas information that has already been transmitted is usually not transmitted again. Also, even if the terminal processing unit A11 determines that the predetermined time has passed, the terminal processing unit A11 usually does not determine that it is the time to transmit gas information until a predetermined period (for example, one day) elapses.

(Step S408) The terminal processing unit A11 acquires gas use information and so on to be transmitted, from the terminal storage unit A10. The gas use information and so on are, for example, a set of pieces of information composed of gas use information and time information, gas use information alone, gas use information and a cylinder identifier, or a set of pieces of information composed of gas use information, a cylinder identifier, and time information.

(Step S409) The terminal processing unit A11 acquires a customer identifier from the terminal storage unit A10.

(Step S410) The terminal processing unit A11 forms gas information and so on to be transmitted. Gas information contains, for example, a plurality of pieces of gas use information and so on and one or more identifiers. The one or more identifiers are, for example, one or more pieces of information of; a customer identifier; and a cylinder identifier.

(Step S411) The terminal transmission unit A12 transmits the gas information and so on formed in step S410 to the information processing apparatus A2.

(Step S412) The terminal processing unit A11 deletes the transmitted gas use information and so on. Here, a flag indicating that the information has been transmitted may be accumulated in association with the transmitted gas use information and so on. Such addition of a flag may be regarded as the same as the deletion. Processing returns to step S401.

In the flowchart shown in FIG. 4, the number of times gas use information is accumulated is larger than the number of times gas information is transmitted. That is to say, in the flowchart shown in FIG. 4, a plurality of pieces of gas use information are transmitted to the information processing apparatus A2 all at once. As a result, the power consumption of the gas information transmission apparatus A1 can be reduced, and the frequency of battery replacement of the gas information transmission apparatus A1 can be reduced. However, in the flowchart shown in FIG. 4, gas information may be transmitted each time gas use information is acquired.

In the flowchart shown in FIG. 4, processing is terminated when power is turned off or an interruption is made to terminate the processing.

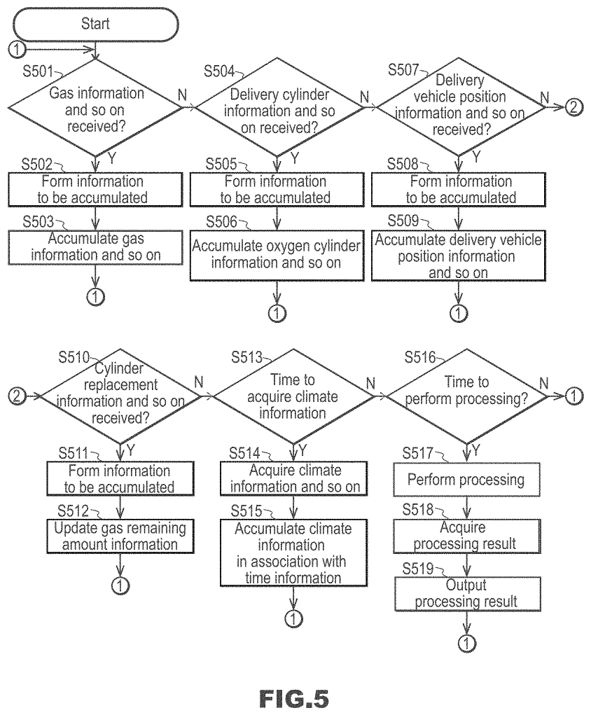

Next, examples of operations that are performed by the information processing apparatus A2 will be described with reference to the flowchart shown in FIG. 5.

(Step S501) The gas information reception unit A221 determines whether or not gas information and so on transmitted from the gas information transmission apparatuses A1 have been received. If gas information and so on have been received, processing proceeds to step S502, and if gas information and so on have not been received, processing proceeds to step S504. Gas information and so on are, for example, gas information and one or more identifiers. The one or more identifiers are, for example, one or more pieces of information of: a customer identifier; and a cylinder identifier.

(Step S502) The gas information accumulation unit A231 forms gas information and so on to be accumulated, using the gas information and so on received in step S501.

(Step S503) The gas information accumulation unit A231 accumulates the gas information and so on formed in step S502 in the gas information storage unit A212. Processing returns to step S501.

(Step S504) The delivery cylinder information reception unit A222 determines whether or not delivery cylinder information and so on have been received. If delivery cylinder information and so on have been received, processing proceeds to step S505, and if delivery cylinder information and so on have not been received, processing proceeds to step S507. Delivery cylinder information and so on are, for example, delivery cylinder information and one or more identifiers. The one or more identifiers are, for example, one or more pieces of information of: a cylinder identifier; a deliverer identifier; and a delivery vehicle identifier.

(Step S505) The delivery cylinder information accumulation unit A232 forms delivery cylinder information and so on to be accumulated, using the delivery cylinder information and so on received in step S504.

(Step S506) The delivery cylinder information accumulation unit A232 accumulates the delivery cylinder information and so on formed in step S505, in the delivery cylinder information storage unit A213. Processing returns to step S501.

(Step S507) The delivery vehicle position information reception unit A223 determines whether or not delivery vehicle position information and so on have been received. If delivery vehicle position information and so on have been received, processing proceeds to step S508, and if delivery vehicle position information and so on have not been received, processing proceeds to step S510. Delivery vehicle position information and so on are, for example, delivery vehicle position information and one or more identifiers. The one or more identifiers are, for example, one or more pieces of information of: a deliverer identifier; and a delivery vehicle identifier.

(Step S508) The delivery vehicle position information accumulation unit A233 forms delivery vehicle position information and so on to be accumulated, using the delivery vehicle position information and so on received in step S507.

(Step S509) The delivery vehicle position information accumulation unit A233 accumulates the delivery vehicle position information and so on formed in step S508, in the delivery vehicle position information storage unit A214. Processing returns to step S501.

(Step S510) Cylinder replacement information reception unit A225 determines whether or not cylinder replacement information and so on have been received. If cylinder replacement information and so on have been received, processing proceeds to step S511, and if cylinder replacement information and so on have not been received, processing proceeds to step S513. Cylinder replacement information and so on are, for example, cylinder replacement information and one or more identifiers. The one or more identifiers are, for example, one or more pieces of information of; a customer identifier; and a cylinder identifier.

(Step S511) The cylinder replacement information accumulation unit A235 forms cylinder replacement information and so on to be accumulated, using the cylinder replacement information and so on received in step S510.

(Step S512) The cylinder replacement information accumulation unit A235 updates the gas remaining amount information regarding the customer information storage unit A211, using the cylinder replacement information and so on formed in step S511. Processing returns to step S501.

(Step S513) The processing unit A23 determines whether or not it is the time to acquire climate information. If it is the time to acquire climate information, processing proceeds to step S514, and if it is not the time to acquire climate information, processing proceeds to step S516. Note that the time to acquire climate information is, for example, every one hour, every one day, or the like.

(Step S514) The climate information acceptance unit A224 acquires climate information and so on from a server (not shown). Here, the climate information acceptance unit A224 may acquire climate information and so on regarding two or more regions, for example.

(Step S515) The climate information accumulation unit A234 accumulates the climate information and so on acquired in step S514 in association with time information, in the climate information storage unit A215. Processing returns to step S501. Climate information and so on are, for example, climate information and time information. The climate information accumulation unit A234 may accumulate climate information and so on in association with time information and a region identifier that identifies a region, in the climate information storage unit A215.

(Step S516) The processing unit A23 determines whether or not it is the time to perform processing, using gas information. If it is the time to perform processing, processing proceeds to step S517, and if it is not the time to perform processing, processing returns to step S501.

(Step S517) The processing unit A23 preforms predetermined processing. Examples of predetermined processing include delivery date prediction processing, delivery control processing, futures trading processing, residence stay processing, energy optimum plan presentation processing, household credit rating acquisition processing, and statistical processing.

(Step S518) The processing unit A23 acquires a processing result that is information that specifies the result of processing performed in step S517.

(Step S519) The processing result output unit A241 outputs the processing result acquired in step S518. Processing returns to step S501.

In the flowchart shown in FIG. 5, processing is terminated when power is turned off or an interruption is made to terminate the processing.

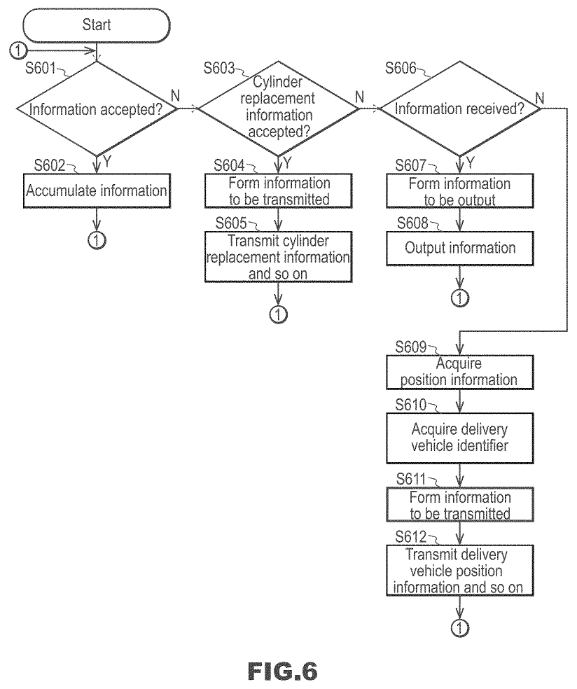

Next, examples of operations that are performed by each deliverer terminal A3 will be described with reference to the flowchart shown in FIG. 6.

(Step S601) The deliverer acceptance unit A32 determines whether or not information has been accepted. If information has been accepted, processing proceeds to step S602, and if information has not been accepted, processing proceeds to step S603. Examples of information include a customer identifier and a cylinder identifier.

(Step S602) The deliverer processing unit A33 at least temporarily accumulate the information accepted in step S601, in the deliverer storage unit A31. Processing returns to step S601.

(Step S603) The deliverer acceptance unit A32 determines whether or not cylinder replacement information has been accepted. If cylinder replacement information has been accepted, processing proceeds to step S604, and if cylinder replacement information has not been accepted, processing proceeds to step S606.

(Step S604) The deliverer processing unit A33 forms cylinder replacement information and so on to be transmitted. Cylinder replacement information and so on contain, for example, a customer identifier and a cylinder identifier.

(Step S605) The deliverer transmission unit A34 transmits the cylinder replacement information and so on formed in step S604 to the information processing apparatus A2. Processing returns to step S601.

(Step S606) The deliverer reception unit A35 determines whether or not information has been received. If information has been received, processing proceeds to step S607, and if information has not been received, processing proceeds to step S609. Note that examples of information include customer information and a delivery list. The delivery list is information regarding a list of customers to which the deliverer delivers gas cylinders.

(Step S607) The deliverer processing unit A33 forms information that is to be output, using the information received in step S606. Examples of information that is to be output include customer information, a delivery list, a map that explicitly shows the position specified by the customer position information contained in the customer information, and route information that is the result of a search for a route from the position specified by delivery vehicle position information to the position specified by the customer position information. Note that the deliverer processing unit A33 may have the function of acquiring delivery vehicle position information (for example, the function of a GPS receiver) and a route search function.

(Step S608) The deliverer output unit A36 outputs the information formed in step S607. Processing returns to step S601.

(Step S609) The deliverer processing unit A33 acquires position information regarding the delivery vehicle. Note that when the deliverer processing unit A33 acquires position information, the deliverer processing unit A33 typically has a GPS receiver, but may use another means to acquire position information. The other means uses, for example, the strength of radio waves transmitted from three or more radio base stations, to perform processing, for example.

(Step S610) The deliverer processing unit A33 acquires a delivery vehicle identifier from the deliverer storage unit A31.

(Step S611) The deliverer processing unit A33 forms delivery vehicle position information and so on to be transmitted, using the delivery vehicle position information acquired in step S609 and the delivery vehicle identifier acquired in step S610.

(Step S612) The deliverer transmission unit A34 transmits the delivery vehicle position information and so on formed in step S611 to the information processing apparatus A2. Processing returns to step S601.

Note that there is no limitation on the time at which the delivery vehicle position information is transmitted in the flowchart shown in FIG. 6.

In the flowchart shown in FIG. 6, processing is terminated when power is turned off or an interruption is made to terminate the processing.

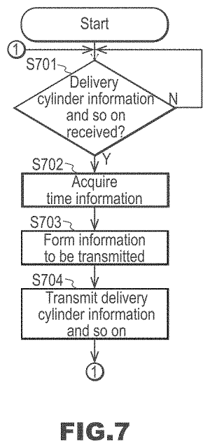

Next, examples of operations that are performed by each facility terminal A4 will be described with reference to the flowchart shown in FIG. 7.

(Step S701) The facility reception unit A45 determines whether or not delivery cylinder information and so on have been received. If delivery cylinder information and so on have been received, processing proceeds to step S702, and if delivery cylinder information and so on have not been received, processing returns to step S701.

(Step S702) The facility processing unit A43 acquires time information from a clock (not shown).

(Step S703) The facility processing unit A43 forms delivery cylinder information and so on to be transmitted, using the delivery cylinder information and so on received in step S701 and the time information acquired in step S702.

(Step S704) The facility transmission unit A44 transmits the delivery cylinder information and so on formed in step S703 to the information processing apparatus A2. Processing returns to step S701.

In the flowchart shown in FIG. 7, processing is terminated when power is turned off or an interruption is made to terminate the processing.

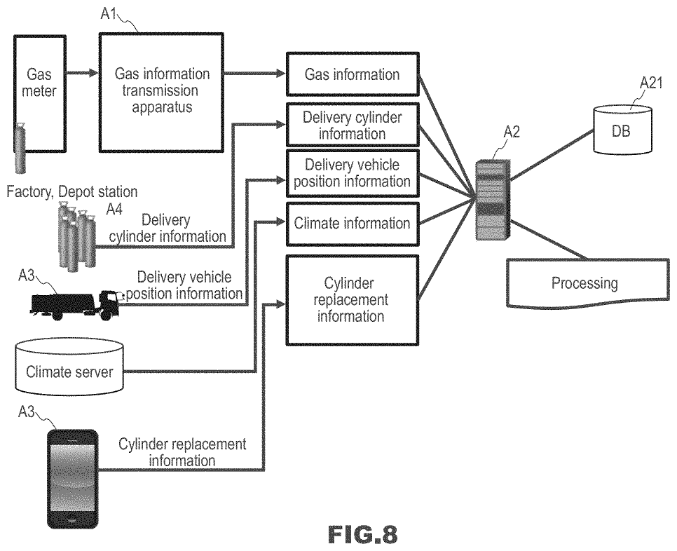

The following describes specific examples of operations that are performed by the information system A according to the present embodiment with reference to a conceptual diagram (FIG. 8) for processing that is performed by the information system A. Note that the conceptual diagram for the system structure of the information system A is FIG. 1.

In the information system A, as described above, pieces of gas information are transmitted from the gas information transmission apparatuses A1 to the information processing apparatus A2 at appropriate points in time, and are accumulated in the information processing apparatus A2. Also, pieces of delivery vehicle position information are transmitted from the deliverer terminals A3 to the information processing apparatus A2, and are accumulated in the information processing apparatus A2. Also, pieces of delivery cylinder information are transmitted from the facility terminals A4 to the information processing apparatus A2, and are accumulated in the information processing apparatus A2. Also, pieces of cylinder replacement information are transmitted from the deliverer terminals A3 to the information processing apparatus A2, and are accumulated in the information processing apparatus A2. Also, the information processing apparatus A2 receives and accumulates climate information from a climate server (not shown). Note that the climate server is a server that stores climate information.

The deliverer terminals A3 that transmit delivery vehicle position information and the deliverer terminals A3 that transmit the deliverer terminals A3 are terminals used by deliverers, and, needless to say, they may be different terminals.

In the information processing apparatus A2, the processing unit A23 performs various kinds of processing, using various kinds of information accumulated in the DB (A21). Examples of the various kinds of processing include delivery date prediction processing, delivery control processing, futures trading processing, residence stay processing, energy optimum plan presentation processing, and household credit rating acquisition processing. Examples of the various kinds of processing may also include processing performed to simply output the results of the above-described statistical processing and various kinds of accumulated information.

As described above, according to the present embodiment, the gas information and so on that contain gas use information regarding the use of LPG cylinders can be collected and used.

In addition, according to the present embodiment, the power consumption of the power source of the gas information transmission apparatuses A1 can be reduced by efficiently transmitting gas information.

In addition, according to the present embodiment, delivery cylinder information that is information regarding the cylinders to be delivered can also be collected and used.

In addition, according to the present embodiment, delivery cylinder information that is information that contains cylinder type information can also be collected and used.

In addition, according to the present embodiment, climate information can also be acquired and used.

Furthermore, according to the present embodiment, cylinder replacement information can be received and used when a cylinder is replaced.

Note that the processing in the present embodiment may be realized using software. This software may be distributed through software downloading or the like. Also, this software may be recorded on a recording medium such as a CD-ROM and distributed. Note that the same applies to the other embodiments in the present description. The software that realizes the gas information transmission apparatuses A1 in the present embodiment is the program described below. That is to say, this program is a program that enables a computer that can access a terminal storage unit that stores pieces of gas information as of two or more points in time to function as: a terminal acquisition unit that acquires gas information that is information that includes gas use information regarding use of gas in an LPG cylinder and corresponds to a cylinder identifier that identifies an LPG cylinder; a terminal accumulation unit that accumulates the gas information acquired by the terminal acquisition unit, in the terminal storage unit; a terminal transmission unit that, when a predetermined condition is satisfied, transmits the pieces gas information as of the two or more pints in time stored in the terminal storage unit to the information processing apparatus in association with a customer identifier.

The software that realizes the information processing apparatus A2 in the present embodiment is the program described below. That is to say, this program is a program that enables a computer that can access a gas storage unit that stores two or more pieces of gas information in association with time information that specifies time, and with a customer identifier, to function as: a gas information reception unit that receives gas information that is associated with a customer identifier, from a gas information transmission apparatus that includes a terminal acquisition unit that acquires gas information that is information that includes gas use information regarding use of gas in an LPG cylinder and corresponds to a customer identifier, and a terminal transmission unit that transmits the gas information acquired by the terminal acquisition unit to the information processing apparatus; a gas information accumulation unit that accumulates the gas information received by the gas information reception unit, in the gas information storage unit in association with time information, and with a customer identifier; and a processing unit that performs predetermined processing, using two or more pieces of gas information stored in the gas information storage unit.

### Embodiment 2

The present embodiment describes an information system that includes an information processing apparatus that determines the price of LPG, using gas use information and climate information.

The present embodiment also describes an information system that includes an information processing apparatus that determines the price of LPG, using one or more pieces of related information of: gas price information regarding a gas price; exchange information regarding an exchange rate; and operation status information regarding an operation status of a gas tanker.

In addition, the present embodiment describes an information system that includes a server apparatus that supports futures trading.

Furthermore, the present embodiment describes an information system that includes a server apparatus that changes the price according to the result of futures trading.

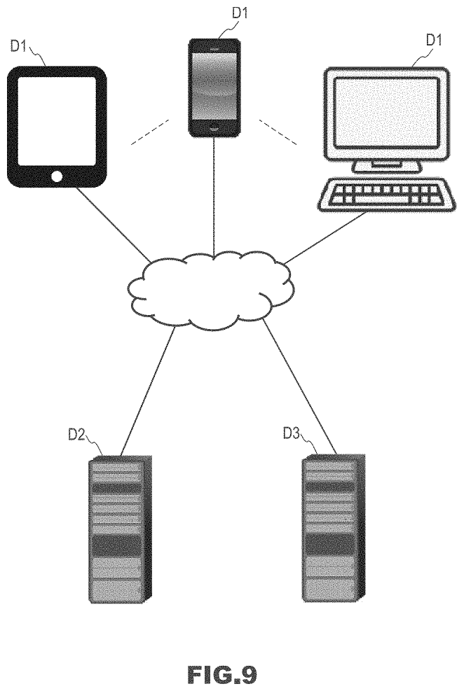

FIG. 9 is a conceptual diagram for an information system D according to the present embodiment. The information system D includes one or more terminal apparatuses D1, an information processing apparatus D2, and a server apparatus D3.

The terminal apparatuses D1 are, for example, terminals that instruct the information processing apparatus D2 to start operating.

The terminal apparatuses D1 are, for example, terminals that transmit a purchase instruction for futures trading of LPG to the server apparatus D3. The terminal apparatuses D1 are, for example, smartphones, tablet terminals, so-called personal computers, or the like, but there is no limitation on the type thereof.

The information processing apparatus D2 is an apparatus that determines the future price of LPG. It is preferable that the price is a variable price.

The information processing apparatus D2 can be realized using a so-called cloud server or an ASP server, but there is no limitation on the type thereof. Note that the information processing apparatus D2 may have some or all of the functions of the information processing apparatus A2. That is to say, the information processing apparatus D2 may be an information processing apparatus A2 that performs futures trading processing. It can be said that futures trading processing is processing through which the future price of LPG is determined.

The server apparatus D3 is an apparatus that supports futures trading. The server apparatus D3 can be realized using a so-called cloud server or an ASP server, but there is no limitation on the type thereof.

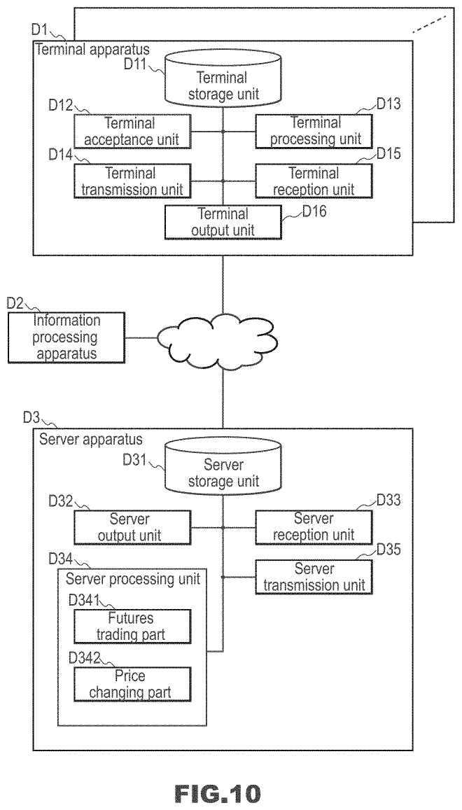

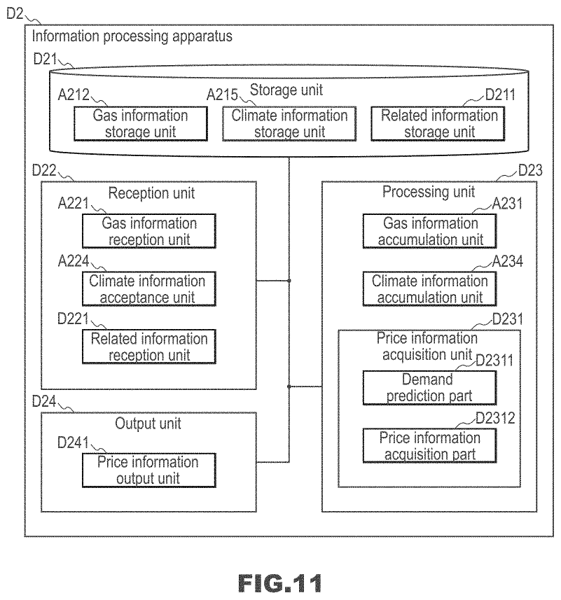

FIG. 10 is a block diagram for the information system D according to the present embodiment. FIG. 11 is a block diagram for the information processing apparatus D2.

The terminal apparatuses D1 included in the information system D each include a terminal storage unit D11, a terminal acceptance unit D12, a terminal processing unit D13, a terminal transmission unit D14, a terminal reception unit D15, and a terminal output unit D16.

The information processing apparatus D2 includes a storage unit D21, a reception unit D22, a processing unit D23, and an output unit D24.

The storage unit D21 includes the gas information storage unit A212, the climate information storage unit A215, and a related information storage unit D211.

The reception unit D22 includes the gas information reception unit A221, the climate information acceptance unit A224, and a related information reception unit D221.

The processing unit D23 includes the gas information accumulation unit A231, the climate information accumulation unit A234, and a price information acquisition unit D231.

The price information acquisition unit D231 includes a demand prediction part D2311 and a price information acquisition part D2312.

The output unit D24 includes a price information output unit D241.

The server apparatus D3 includes a server storage unit D31, a server output unit D32, a server reception unit D33, a server processing unit D34, and a server transmission unit D35.

The server processing unit D34 includes a futures trading part D341 and a price changing part D342.

The terminal storage unit D11 included in each terminal apparatus D1 stores various kinds of information. Examples of the various kinds of information include a user identifier and a terminal identifier that identifies the terminal apparatus D1. Note that this user identifier is identification information regarding a user who inputs a purchase instruction, which will be described below. The user identifier is, for example, an ID, a mail address, a telephone number, or the like.

The terminal acceptance unit D12 accepts various kinds of information, instructions, and so on. Examples of the various kinds of information, instructions, and so on include a purchase instruction and an operation start instruction, which will be described later. Note that an operation start instruction is an instruction that instructs the information processing apparatus D2 to start operating. It is preferable that a terminal apparatus D1 that accepts a purchase instruction and a terminal apparatus D1 that accepts an operation start instruction are different from each other. The terminal apparatus D1 that accepts a purchase instruction is a terminal of a user who carries out futures trading. The terminal apparatus D1 that accepts an operation start instruction is, for example, a terminal of an operator of the information processing apparatus D2.

Any input means may be employed to input various kinds of information, instructions, and so on, such as a touch panel, a keyboard, a mouse, a menu screen, or the like. The terminal acceptance unit D12 can be realized using a device driver for the input means such as a touch panel or a keyboard, or control software or the like for controlling the menu screen.

The terminal processing unit D13 performs various kinds of processing. Examples of the various kinds of processing include processing that is performed by the terminal acceptance unit D12 to convert the various kinds of information, instructions, and so on accepted thereby into a data structure that contains the various kinds of information, instructions, and so on to be transmitted. Examples of the various kinds of processing also include processing that is performed to convert the information received by the terminal reception unit D15 so as to have a data structure that is to be output.

The terminal transmission unit D14 transmits various kinds of information to the information processing apparatus D2 or the server apparatus D3. Examples of the various kinds of information include a purchase instruction and an operation start instruction, which will be described later.

The terminal reception unit D15 receives various kinds of information. Examples of the various kinds of information include the result of futures trading processing, screen information regarding a web page for futures trading, an operation completion notification, and price information. Note that an operation completion notification is information that indicates that price information acquisition processing is complete, in response to an operation start instruction being transmitted, in the information processing apparatus D2.

The terminal output unit D16 outputs various kinds of information. Examples of the various kinds of information include information formed by the terminal processing unit D13. Examples of the various kinds of information include a web page for futures trading and price information.

Here, “output” is a concept that includes means displaying on a display device, projection with a projector, printing with a printer, sound output, transmission to an external apparatus, accumulation on a recording medium, delivery of processing results to another processing apparatus or another program, and so on.

The storage unit D21 included in the information processing apparatus D2 stores various kinds of information. Examples of the various kinds of information include gas information, climate information, related information, price information, one or more calculation formulas (may also be referred to as functions), and a learner, which will be described later.

The gas information storage unit A212 stores two or more pieces of gas information that include gas use information regarding two or more households.

The climate information storage unit A215 stores climate information that is associated with date information. It is preferable that the climate information storage unit A215 stores, for example, climate information up to three months ahead. It is preferable that the climate information here is a predicted weather and a predicted temperature.

The related information storage unit D211 stores one or more pieces of related information. Related information is information that may affect LPG pricing. Examples of related information include gas price information, exchange information, and operation status information.

Gas price information is information regarding the price of gas. Gas price information is, for example, one or more pieces of information of: Middle Eastern gas price information that specifies the Middle East gas price; and MB gas price information that specifies the MB (Mont Belvieu) gas price. Note that the Middle Eastern gas price is the price of gas in oil-producing countries in the Middle East. The MB gas price is the propane trading price at the LPG terminal in Mont Belvieu, Tex.

Exchange information is information regarding exchange. Exchange information indicates, for example, the dollar-yen rate.

Operation status information is information regarding the operation status of a gas tanker. Operation status information is, for example, information indicating the occurrence of a problem, information indicating the absence of a trouble, information indicating that a problem occurred within a threshold period (for example, the last one month), information indicating that a problem has not occurred within a threshold period (for example, the last one month), or information indicating the content or type of the trouble.

The reception unit D22 receives various kinds of information. Examples of the various kinds of information include gas information, climate information, related information, and an operation start instruction.

The gas information reception unit A221 receives gas information from a gas information transmission apparatus A1.

The climate information acceptance unit A224 receives climate information that is associated with time information that specifies the time. Here, “acceptance” typically means, for example, reception of information transmitted from a server apparatus (not shown) via a wired or wireless communication line, but may be regarded as a concept that includes acceptance of information input from an input device such as a keyboard, a mouse, or a touch panel, or acceptance of information read from a recording medium such as an optical disk, a magnetic disk, or a semiconductor memory.

The related information reception unit D221 receives related information. The related information reception unit D221 receives one or more pieces of related information from a server (not shown).

The processing unit D23 performs various kinds of processing. Examples of the various kinds of processing include processing that is performed by the gas information accumulation unit A231, processing that is performed by the climate information accumulation unit A234, and processing that is performed by the price information acquisition unit D231.

The price information acquisition unit D231 acquires price information that specifies the price of LPG per unit amount at the time specified by time information, using gas use information regarding two or more households and climate information. The time specified by time information typically is a date that is specified by date information. However, the time specified by time information may be a period that is longer than one day.

It is preferable that the price information acquisition unit D231 acquires price information regarding one or more days that are ahead by the predetermined period, using gas use information regarding two or more households, climate information, and one or more pieces of related information.

The price information acquisition unit D231 acquires price information that indicates a higher price as the amount of gas used indicated by the gas use information regarding two or more households increases. The price information acquisition unit D231 acquires, for example, a higher price as the predicted demand amount described later increases.

The price information acquisition unit D231 typically acquires price information that indicates a higher price as the temperature specified by climate information decreases.

The price information acquisition unit D231 typically acquires price information that indicates a higher price as the weather specified by climate information is worse (for example, when it often rains, compared to when it is sunny).

The price information acquisition unit D231 typically acquires price information that indicates a higher price as the price specified by gas price information increases.

The price information acquisition unit D231 typically acquires price information that indicates a higher price as exchange information indicates a lower yen.

The following describes the details of an example of processing that is performed by the price information acquisition unit D231. Here, processing that is performed when price information is to be acquired by the demand prediction part D2311 and the price information acquisition part D2312 will be described.

### (1) Demand Prediction by Demand Prediction Part D2311

The demand prediction part D2311 acquires a predicted demand amount that is the amount of future demand for LPG, using gas use information regarding two or more households. Note that the predicted demand amount is the amount of future demand for LPG and is the total annual use, for example, but there is no limitation on the period.

The following three methods can be used to acquire the predicted demand amount, for example.

### (1-1) Calculation Method

The demand prediction part D2311 acquires gas use information in the past regarding two or more households from the gas information storage unit A212, for example. Thereafter, the demand prediction part D2311 acquires the total use amount of gas of two or more households from the gas use information regarding the two or more households. Next, the demand prediction part D2311 acquires a predicted demand amount, using an increasing function that has the total amount as a parameter, for example.

### (1-2) Correspondence Table Method

The demand prediction part D2311 acquires the total use amount of gas of two or more households from the gas use information regarding the two or more households, and acquires a predicted demand amount corresponding to the total amount, from a correspondence table, for example. Note that such a correspondence table is a table that contains two or more pieces of correspondence information that each contain information regarding the range of the total amount of gas used (the total amount of use in the past) and a predicted demand amount.

The demand prediction part D2311 acquires the predicted demand amount through machine learning, for example. The following describes an example of an algorithm for acquiring a predicted demand amount, using machine learning.

### (1-3) Machine Learning Method

The following describes processing that is performed to form a learner, and processing that is performed to acquire a predicted demand amount.

(1-3-1) Processing that is Performed to Form Leaner

The demand prediction part D2311 acquires gas use information in the past regarding two or more households from the gas information storage unit A212, for example. Note that the past gas use information in the past is, for example, gas use information in January of each of two or more years (for example, 2010, 2011, . . . , and 2018).

Also, the demand prediction part D2311 totals the use amounts indicated by the gas use information in the past regarding two or more households in each of two or more years, to calculate the total amount of gas used in a year.

Next, the demand prediction part D2311 acquires a learner, to which gas use information for a short period (for example, January, January-March, and January-June) is input and that outputs the total amount of gas used in a year, using a machine learning algorithm. It is preferable that the short period is included in the year for which the total amount of gas used is to be acquired, but may be a period that is not included in the year for which the total amount of gas used is to be acquired.

That is to say, the demand prediction part D2311 acquires, for each year, a set of short-period gas use information and the total amount of gas used in the year, and forms learning source information that contains a plurality of sets. Next, the demand prediction part D2311 provides the learning source information to a module for forming a learner for machine learning, executes the module to form a learner, and accumulates the learner in the storage unit D21. Note that there is no limitation on the machine learning algorithm, which may be, for example, deep learning, random forest, SVR, or the like. In addition, the machine learning module may be any module, such as a TensorFlow module, fastText, TinySvm, any kind of RandomForest function, or the like. The learner may be referred to as a classifier.

Furthermore, in the above, to form a learner, the demand prediction part D2311 may use gas use information regarding one month, or gas use information regarding two or more months, or gas use information regarding a predetermined period (for example, one month, three months, six months, twelve months, or the like) in the previous year, for example.

(1-3-2) Processing that is Performed to Acquire Predicted Demand Amount

The demand prediction part D2311 acquires gas use information regarding a period that is equivalent to the period of gas use information used to form the learner (for example, January to February in the last year) and that corresponds to the amount of demand to be predicted (for example, January to February in this year), from the gas information storage unit A212, for example.

Next, the demand prediction part D2311 acquires the annual predicted demand amount, using a machine learning algorithm, and using the acquired gas use information and the learner in the storage unit D21. That is to say, the demand prediction part D2311 forms, for example, a vector that has each use amount in the acquired gas use information as an element, provides the vector and the learner in the storage unit D21 to the module that performs machine learning prediction, and acquires the annual predicted demand amount, using a machine learning algorithm, for example. Note that there is no limitation on the machine learning algorithm in the case of such prediction as well, which may be, for example, deep learning, random forest, SVR, or the like. In addition, the machine learning module for prediction may be any module, such as a TensorFlow module, fastText, TinySvm, any kind of RandomForest function, or the like. Note that the “prediction” here means processing through which the annual predicted demand amount is acquired.

(2) Price Information Determination Processing by Price Information Acquisition part D2312

The price information acquisition part D2312 acquires price information regarding LPG on each of one or more days, using the predicted demand amount acquired by the demand prediction part D2311 and climate information.

The following three methods can be used as a method for acquiring price information, using the predicted demand amount, for example.

### (2-1) Calculation Method

The price information acquisition part D2312 acquires one or more pieces of related information from the related information storage unit D211, for example. Thereafter, for example, the price information acquisition part D2312 substitutes the predicted demand amount and one or more pieces of related information as parameters into the calculation formula, executes the calculation formula, and obtains reference price information.

Next, for example, the price information acquisition part D2312 corrects the reference price information to obtain corrected price information, using one or more pieces of information of: temperature information that is contained in weather information regarding each of the days for which the price is to be determined; and weather information.

Note that, for example, when the temperature information indicates a temperature that is high enough to satisfy a predetermined first condition, price information acquisition part D2312 reduces the price information by a predetermined amount or according to temperature information. Also, when the temperature information indicates a temperature that is low enough to satisfy a predetermined second condition, the price information acquisition part D2312 increases the price information by a predetermined amount or according to temperature information. Note that the first condition is, for example, that the temperature is “higher than the average temperature of the day stored in the storage unit D21 by an amount that is no less than a threshold value” or is “higher than the average temperature of the day stored in the storage unit D21 by an amount that is greater than a threshold value”. The second condition is, for example, that the temperature is “lower than the average temperature of the day stored in the storage unit D21 by an amount that is no less than a threshold value” or is “lower than the average temperature of the day stored in the storage unit D21 by an amount that is greater than a threshold value”.

Also, the price information acquisition part D2312 corrects the reference price information according to the weather information, and acquires the corrected price information, for example. When weather information is information indicating “rainy”, for example, the price information acquisition part D2312 raises the price information by a predetermined amount. When weather information is information indicating “sunny”, for example, the price information acquisition part D2312 lowers the price information by a predetermined amount.

### (2-2) Correspondence Table Method

It is assumed that the storage unit D21 stores a correspondence table consisting of two or more pieces of correspondence information that contains “a condition regarding predicted demand amount” or “a condition regarding predicted demand amount and one or more pieces of related information”, and “price information”. Note that the “condition regarding the predicted demand amount” is, for example, that the range of the predicted demand amount (for example, y1<=predicted demand amount <y2). The “condition regarding predicted demand amount and one or more pieces of related information” is, for example, a condition that includes the range of the predicted demand amount (for example, “y1<=predicted demand amount <y2” and the range of exchange (for example, “z1<=yen/1 dollar <z2”).

Thereafter, the price information acquisition part D2312 acquires one or more pieces of related information from the related information storage unit D211, for example. Thereafter, the price information acquisition part D2312, for example, acquires price information corresponding to the predicted demand amount and one or more pieces of related information, from the correspondence table, and obtains reference price information.

Next, as in (2-1), the price information acquisition part D2312 corrects the reference price information to obtain corrected price information, using one or more pieces of information of; temperature information that is contained in weather information regarding each of the days for which the price is to be determined; and weather information.

### (2-3) Machine Learning Method

(2-3-1) Processing that is Performed to Form Leaner

The price information acquisition part D2312 acquires a learner, using a machine learning algorithm, and using a plurality of sets of: the predicted demand amount in the past; one or more pieces of related information in the past; climate information in the past; and price information in the past, as learning source information, for example. This learner is a learner to which a predicted demand amount, one or more pieces of related information, and climate information are input, and that outputs price information.

More specifically, the price information acquisition part D2312 provides the above learning source information to a module for forming a learner for machine learning, executes the module to form a learner, and accumulates the learner in the storage unit D21. Note that there is no limitation on the machine learning algorithm, which may be, for example, deep learning, random forest, SVR, or the like. In addition, the machine learning module may be any module, such as a TensorFlow module, fastText, TinySvm, any kind of RandomForest function, or the like. The learner may be referred to as a classifier.

(2-3-2) Processing that is Performed to Acquire Price Information

The price information acquisition part D2312 acquires one or more pieces of related information from the related information storage unit D211, for example. Also, the price information acquisition part D2312 acquires climate information regarding the target day for which price information is to be acquired, from the climate information storage unit A215, for example. Thereafter, the price information acquisition part D2312 acquires price information, using a machine learning algorithm, and using a predicted demand amount, one or more pieces of related information, climate information, and the learner in the storage unit D21. That is to say, the price information acquisition part D2312 forms a vector, using the acquired predicted demand amount, one or more pieces of related information, and climate information, provides the vector and the learner in the storage unit D21 to a module for performing prediction in machine learning, and acquires price information, using a machine learning algorithm. Note that there is no limitation on the machine learning algorithm in the case of such prediction as well, which may be, for example, deep learning, random forest, SVR, or the like. In addition, the machine learning module for prediction may be any module, such as a TensorFlow module, fastText, TinySvm, any kind of RandomForest function, or the like. Note that the “prediction” here means processing through which price information is acquired.

The output unit D24 outputs various kinds of information. Examples of the various kinds of information include price information.

The price information output unit D241 outputs the price information acquired by the price information acquisition unit D231. It is preferable that the price information output unit D241 outputs the price information acquired by the price information acquisition unit D231, in association with date information that specifies the target day for which price information is to be acquired.

In addition, “output” here means accumulation in the storage unit D21, for example. In addition, “output” means transmission to the server apparatus D3, for example. In addition, “output” means display, for example. When “output” means display, the output unit D24 may be regarded as including or not including an output device such as a display or a speaker. The output unit D24 can be realized using the driver software of the output device, the driver software of the output device and the output device, or the like.

The server storage unit D31 included in the server apparatus D3 stores various kinds of information. Examples of the various kinds of information include one or more pieces of price information output by the information processing apparatus D2. Note that one or more pieces of price information typically are associated with date information.

The server output unit D32 outputs the price information stored in the server storage unit D31. The server output unit D32 outputs price information upon receiving a user instruction, for example. “Output” here typically means transmission to a user terminal (not shown), but may include a concept such as display.

The server output unit D32 outputs the price information changed by the price changing part D342. “Output” here typically means transmission to a user terminal (not shown), but may include a concept such as display.

The server reception unit D33 receives a purchase instruction. The purchase instruction is a purchase instruction corresponding to the price information output by the server output unit D32. The purchase instruction contains, for example, a user identifier, amount information that specifies an amount, and date information.

The server processing unit D34 performs futures trading processing, which will be described later, in response to the purchase instruction. In addition, the server processing unit D34 performs price changing processing, which will be described later.

The futures trading part D341 performs futures trading processing. Futures trading processing is processing through which a purchase reservation for the amount of LPG specified by amount information is made at the price specified by price information. Note that a purchase instruction contains, for example, date information, amount information, and price information. In addition, a purchase instruction is associated with a user identifier, for example.

Futures trading processing may be any processing as long as it is processing for purchase reservation for LPG. Futures trading processing is, for example, processing that is performed to form futures trading information that contains a user identifier that identifies a purchaser, price information, amount information, and date information, and accumulates the futures trading information in the server storage unit D31. In addition, futures trading processing is processing that is performed to transmit futures trading information to a terminal that has transmitted the purchase instruction, for example.

The price changing part D342 performs price changing processing. Upon a purchase instruction being accepted, the price changing part D342 acquires price information obtained by changing the price information stored in the server storage unit D31, and accumulates the price information in the server storage unit D31.

The price changing part D342 raises the price specified by the price information paired with the date information included in the purchase instruction, in response to the purchase instruction, acquires the updated price information, and accumulates the updated price information in pair with the date information, for example.

It is preferable that the price changing part D342 changes price information according to the trading volume, for example. The price changing part D342 obtains information regarding the increasing price, using, for example, an increasing function that uses the trading volume on the corresponding day as a parameter, adds the price information to the current price information, and obtains price information that is to be used for update. The price changing part D342 adds a fixed amount to the current price information in response to the purchase instruction being accepted, and obtains price information that is to be used for update, for example. Also, when trading is not performed or the trading amount is below a threshold value for a predetermined period, the price changing part D342 subtracts a fixed amount from the current price information, and obtains price information that is to be used for update, for example.

The server transmission unit D35 transmits various kinds of information. Examples of the various kinds of information include futures trading information, futures trading processing completion notification, and so on. A futures trading processing completion notification is information indicating that futures trading processing is complete. The server transmission unit D35 transmits various kinds of information to the terminal apparatuses D1, for example.

It is preferable that the terminal storage unit D11, the storage unit D21, the gas information storage unit A212, the climate information storage unit A215, the related information storage unit D211, and the server storage unit D31 are realized using a non-volatile recording medium, but they may be realized using a volatile recording medium.

There is no limitation on the process in which information is stored in the terminal storage unit D11 and so on. For example, information may be stored in the terminal storage unit D11 or the like via a recording medium, or information transmitted via a communication line or the like may be stored in the terminal storage unit D11 or the like, or information input via an input device may be stored in the terminal storage unit D11 or the like.

The terminal processing unit D13, the processing unit D23, the gas information accumulation unit A231, the climate information accumulation unit A234, the price information acquisition unit D231, the demand prediction part D2311, the price information acquisition part D2312, the server processing unit D34, the futures trading part D341, and the price changing part D342 can typically be realized using an MPU, a memory, or the like. The processing procedures performed by the terminal processing unit D13 and so on typically are realized using software, and the software is recorded on a recording medium such as a ROM. However, such processing procedures may be realized using hardware (a dedicated circuit).

The terminal transmission unit D14, the output unit D24, the price information output unit D241, and the server transmission unit D35 are realized using a wireless or wired communication means, but may be realized using a broadcast means.

The terminal reception unit D15, the reception unit D22, and the related information reception unit D221 typically are realized using a wireless or wired communication means, but may be realized using a means for receiving broadcast.

The terminal output unit D16 may be regarded as including or not including an output device such as a display or a speaker. The terminal output unit D16 can be realized using the driver software of the output device, the driver software of the output device and the output device, or the like.

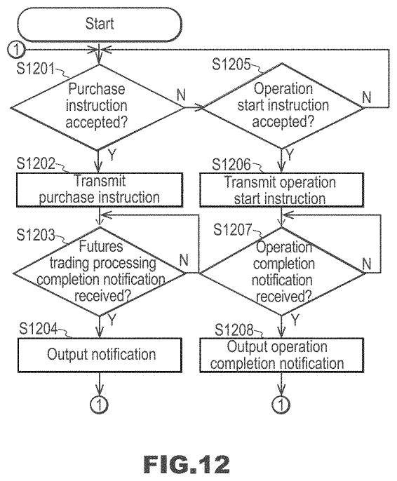

Next, operations that are performed by the information system D will be described. First, examples of operations that are performed by the terminal apparatuses D1 will be described with reference to the flowchart shown in FIG. 12.

(Step S1201) The terminal acceptance unit D12 determines whether or not a purchase instruction has been accepted. If a purchase instruction has been accepted, processing proceeds to Step S1202, and if a purchase instruction has not been accepted, processing proceeds to Step S1205.

(Step S1202) The terminal processing unit D13 converts the purchase instruction accepted in Step S1201, so as to have a structure of a purchase instruction that is to be transmitted. Next, the terminal transmission unit D14 transmits the purchase instruction to the server apparatus D3.

(Step S1203) The terminal reception unit D15 determines whether or not a futures trading processing completion notification has been received. If a futures trading processing completion notification has been received, processing proceeds to Step S1204, and if a futures trading processing completion notification has not been received, processing returns to Step S1203.

(Step S1204) The terminal processing unit D13 converts the futures trading processing completion notification received in Step S1203, so as to have an information structure that is to be output. The terminal output unit D16 outputs the futures trading processing completion notification. Processing returns to Step S1201.

(Step S1205) The terminal acceptance unit D12 determines whether or not an operation start instruction has been accepted. If an operation start instruction has been accepted, processing proceeds to Step S1206, and if an operation start instruction has not been accepted, processing returns to Step S1201.

(Step S1206) The terminal processing unit D13 converts the operation start instruction accepted in Step S1205, so as to have a structure of an operation start instruction that is to be transmitted. Next, the terminal transmission unit D14 transmits the operation start instruction to the information processing apparatus D2.

(Step S1207) The terminal reception unit D15 determines whether or not an operation completion notification has been received from the information processing apparatus D2. If an operation completion notification has been received, processing proceeds to Step S1208, and if an operation completion notification has not been received, processing returns to Step S1207.

(Step S1208) The terminal processing unit D13 converts the operation completion notification received in Step S1207, so as to have a structure of an operation completion notification that is to be output. The terminal output unit D16 outputs the operation completion notification. Processing returns to Step S1201.

In the flowchart shown in FIG. 12, processing is terminated when power is turned off or an interruption is made to terminate the processing.

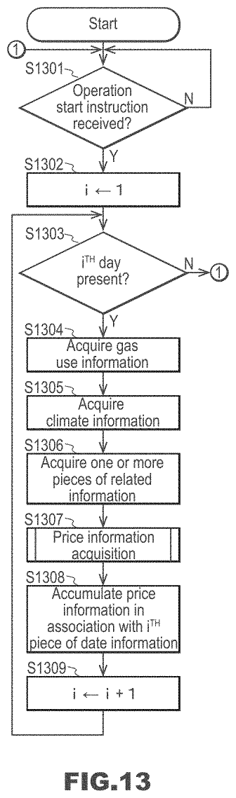

Next, an example of processing that is performed by the information processing apparatus D2 to determine price information will be described with reference to the flowchart shown in FIG. 13.

(Step S1301) The reception unit D22 determines whether or not an operation start instruction has been received. If an operation start instruction has been accepted, processing proceeds to Step S1302, and if an operation start instruction has not been accepted, processing returns to Step S1301.

(Step S1302) The price information acquisition unit D231 substitutes 1 for the counter i.

(Step S1303) The price information acquisition unit D231 determines whether or not the i^{th} day for which price information is to be determined is present. If the i^{th} day is present, processing proceeds to Step S1304, and if the i^{th} day is not present, processing returns to Step S1301. Note that the i^{th} day is, for example, the day specified by the i^{th} piece of date information of the pieces of date information contained in the operation start instruction, or a day within a predetermined period (for example, the one-month period of the month three months after today).

(Step S1304) The price information acquisition unit D231 acquires the gas use information to be used to determine price information, from the gas information storage unit A212.

(Step S1305) The price information acquisition unit D231 acquires climate information corresponding to the date information regarding the i^{th} day, from the climate information storage unit A215. Note that the climate information corresponding to the date information regarding the i^{th} day is weather forecast information.

(Step S1306) The price information acquisition unit D231 acquires one or more pieces of related information from the related information storage unit D211.

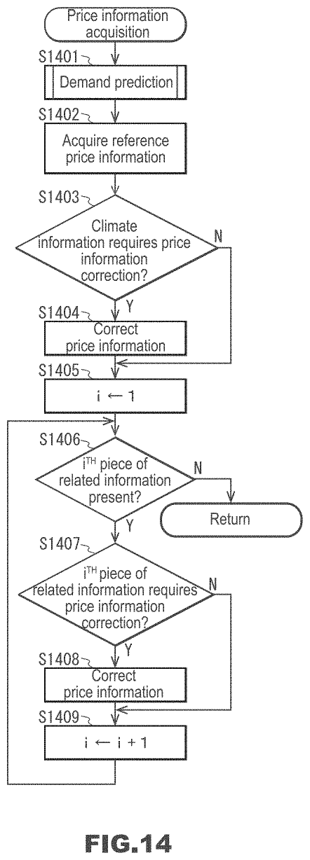

(Step S1307) The price information acquisition unit D231 performs price information acquisition processing. Next, an example of price information acquisition processing will be described with reference to the flowchart shown in FIG. 14.

(Step S1308) The price information acquisition unit D231 accumulates the price information acquired in Step S1307 in the storage unit D21 in association with the date information regarding the i^{th} day. Processing returns to Step S1301. Note that the price information output unit D241 may transmit the price information acquired in Step S1307 to the server apparatus D3 in association with the date information regarding the i^{th} day.

(Step S1309) The price information acquisition unit D231 increments the counter i by 1. Processing returns to Step S1304.

In the flowchart shown in FIG. 13, processing is terminated when power is turned off or an interruption is made to terminate the processing.

Next, an example of the price information acquisition processing in Step S1307 will be described with reference to the flowchart shown in FIG. 14.

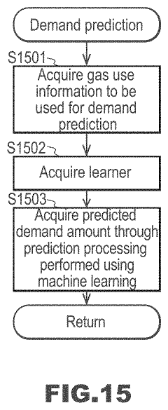

(Step S1401) The demand prediction part D2311 performs demand prediction processing. Demand prediction processing will be described with reference to the flowchart shown in FIG. 15.

(Step S1402) The price information acquisition part D2312 acquires reference price information, using a predicted demand amount, which is the result of the demand prediction processing in Step S1401. Note that the price information acquisition part D2312 acquire price information by substituting the predicted demand amount into an increasing function that uses the predicted demand amount as a parameter, and executing the function. Also, the price information acquisition part D2312 acquires the price information paired with the predicted demand amount, from a correspondence table, for example. In such a case, the correspondence table contains two or more pieces of correspondence information that contains the range of the predicted demand amount and price information.

(Step S1403) The price information acquisition part D2312 determines whether or not the acquired climate information is information in which price information needs to be corrected. If the climate information is such information (for example, if the temperature is above a standard temperature by a value no less than a threshold value, or if the temperature is below a standard temperature by a value no less than a threshold value), processing proceeds to Step S1404, and if the climate information is not such information, processing proceeds to Step S1405.

(Step S1404) The price information acquisition part D2312 corrects the price information. It is preferable that the price information acquisition part D2312 corrects the price information to a different value depending on the climate information.

(Step S1405) The price information acquisition part D2312 substitutes 1 for the counter i.

(Step S1406) The price information acquisition part D2312 determines whether or not the i^{th} related information is present in the acquired related information. If the i^{th} related information is present, processing proceeds to Step S1407, and if the i^{th} related information is not present, processing returns to higher level processing.

(Step S1407) The price information acquisition part D2312 acquires the i^{th} related information, and determines whether or not the i^{th} related information is information whose price information needs to be corrected. If the i^{th} related information is information whose price information needs to be corrected, processing proceeds to Step S1408, and if the i^{th} related information is information whose price information does not need to be corrected, processing proceeds to Step S1409.

(Step S1408) The price information acquisition part D2312 corrects the price information. It is preferable that the price information acquisition part D2312 corrects the price information to a different value depending on the related information.

(Step S1409) The price information acquisition part D2312 increments the counter i by 1. Processing returns to Step S1406.

Next, the demand prediction processing in Step S1401 will be described with reference to the flowchart shown in FIG. 15.

(Step S1501) The demand prediction part D2311 acquires one or more pieces of gas use information that are to be used to perform demand prediction.

(Step S1502) The demand prediction part D2311 acquires the stored learner from the storage unit D21.

(Step S1503) The demand prediction part D2311 acquires a predicted demand amount, using the gas use information acquired in Step S1501 and the learner acquired in Step S1502, and a machine learning algorithm. Processing returns to higher level processing.

Although a machine learning algorithm is used in the flowchart in FIG. 15, it is possible to acquire the predicted demand amount instead of using the machine learning algorithm as described above.

The processing performed to form a learner in the flowchart shown in FIG. 15 has been described above, and therefore the description is omitted here.

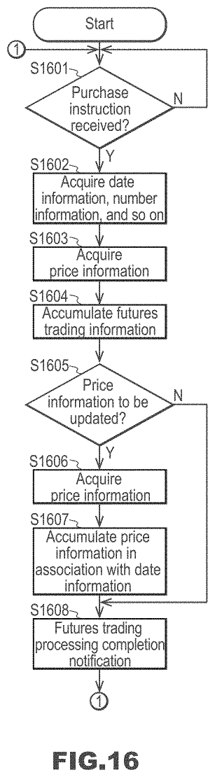

Next, examples of operations that are performed by the server apparatus D3 will be described with reference to the flowchart shown in FIG. 16.

(Step S1601) The server reception unit D33 determines whether or not a purchase instruction has been received from a terminal apparatus D1. If a purchase instruction has been received, processing proceeds to Step S1602, and if a purchase instruction has not been received, processing returns to Step S1601.

(Step S1602) The futures trading part D341 acquires the date information, the amount information, and so on included in the purchase instruction. Examples of the date information, amount information, and so on include date information, amount information, and a user identifier.

(Step S1603) The futures trading part D341 acquires the price information paired with the date information acquired in Step S1602, from the server storage unit D31.

(Step S1604) The futures trading part D341 forms futures trading information that contains a user identifier, price information, amount information, and date information. Thereafter, the server processing unit D34 accumulates the futures trading information in the server storage unit D31. Note that, for example, processing for trading is performed on a later date, using the accumulated futures trading information.

(Step S1605) The price changing part D342 determines whether or not the price information stored in the server storage unit D31 is to be changed. If it is determined that the price information is to be changed, processing proceeds to Step S1606, and if it is determined that the price information is not to be changed, processing proceeds to Step S1608.

Note that the price changing part D342 acquires, for example, the trading volume on the corresponding day, using one or more pieces of amount information paired with the date information regarding the day, and upon determining that the trading volume is no less than a threshold value or greater than the threshold value, the price changing part D342 determines that the price information is to be changed. Note that the price changing part D342 determines that the price information is to be changed every time the price changing part D342 receives a purchase instruction, for example. Note that the price changing part D342 determines that the price information is to be changed on a day if no trading has been carried out for a period that is no less than a threshold value, for example. It is preferable that the price changing part D342 use one or more pieces of: information regarding the trading volume; and information regarding the frequency of trading, to determine whether or not to change price information, using one or more pieces.

(Step S1606) The price changing part D342 acquires the price information to be changed. It is preferable that the price changing part D342 changes the price information such that the higher the trading volume on the corresponding day is, the higher the price is.

(Step S1607) The price changing part D342 accumulates the updated price information in association with date information.

(Step S1608) The server transmission unit D35 transmits a completion notification regarding the futures trading processing, to the terminal apparatus D1. Processing returns to Step S1601.

In the flowchart shown in FIG. 16, processing is terminated when power is turned off or an interruption is made to terminate the processing.

As described above, according to the present embodiment, the price of LPG can be determined using gas use information and climate information.

In addition, according to the present embodiment, the price of LPG can be determined with high accuracy using related information as well.

Furthermore, according to the present embodiment, futures trading of gas can be carried out using gas use information and climate information.

Note that the processing in the present embodiment may be realized using software. This software may be distributed through software downloading or the like. Also, this software may be recorded on a recording medium such as a CD-ROM and distributed. Note that the same applies to the other embodiments in the present description. The software that realizes the information processing apparatus D2 in the present embodiment is the program described below. That is to say, this program is a program that enables a computer that can access a gas information storage unit that stores two or more pieces of gas information that contains gas use information regarding two or more households to function as: a climate information acceptance unit that receives climate information that is associated with time information that specifies time; a price information acquisition unit that acquires price information that specifies a price of LPG per unit amount at the time specified by the time information, using the gas use information regarding two or more households and the weather information; and a price information output unit that outputs the price information acquired by the price information acquisition unit.

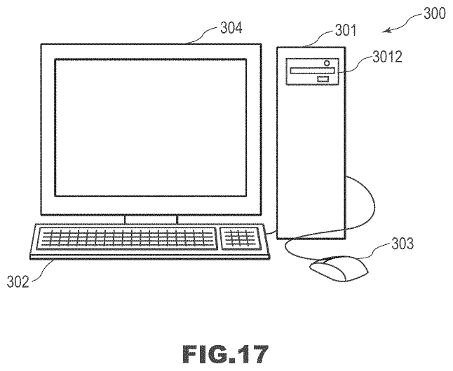

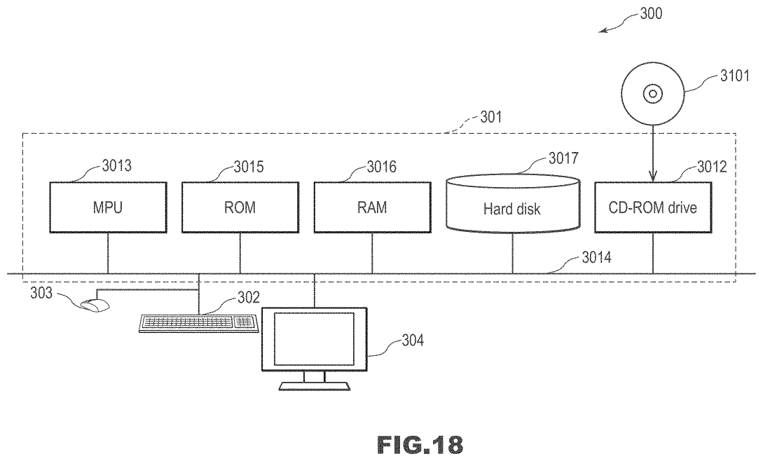

FIG. 17 shows an external appearance of a computer that realizes the information processing apparatus D2 and so on according to the various embodiments described above by executing the programs described in the present description. The above-described embodiments can be realized using computer hardware and a computer program that is executed thereon. FIG. 17 is an overview diagram for this computer system 300, and FIG. 18 is a block diagram for the system 300.

In FIG. 17, the computer system 300 includes a computer 301 that includes a CD-ROM drive, a keyboard 302, a mouse 303, and a monitor 304.

In FIG. 18, the computer 301 includes, in addition to a CD-ROM drive 3012, an MPU 3013, a bus 3014 that is connected to the CD-ROM drive 3012 and so on, a ROM 3015 for storing programs such as a bootup program, a RAM 3016 that is connected to the MPU 3013 to temporarily store an instruction from an application program, and provide a temporary memory space, and a hard disk 3017 for storing an application program, a system program, and data. Although not illustrated here, the computer 301 may further include a network card that provides connection to a LAN.

The program that causes the computer system 300 to execute the functions of the information processing apparatus D2 and so on according to the above-described embodiments may be stored in a CD-ROM 3101, inserted into the CD-ROM drive 3012, and further transferred to the hard disk 3017. Instead, the program may be transmitted to the computer 301 via a network (not shown), and stored in the hard disk 3017. The program is loaded to the RAM 3016 when it is to be executed. The program may be loaded directly from the CD-ROM 3101 or a network.

The program does not necessarily include an operating system (OS) that causes the computer 301 to execute functions such as the information processing apparatus D2 according to the above-described embodiments, a third-party program, or the like. The program need only include an instruction part that calls an appropriate function (module) in a controlled manner to obtain the desired result. It is well known how the computer system 300 works, and therefore detailed description thereof will be omitted.

A single computer or a plurality of computers may execute the above-described program. That is to say, centralized processing or distributed processing may be performed.

Also, as a matter of course, in each of the above-described embodiments, the two or more communication means that exist in one apparatus may be physically realized using one medium.

Furthermore, in each of the above-described embodiments, each kind of processing may be realized through centralized processing that is performed by a single apparatus, or may be realized through distributed processing that is performed by a plurality of apparatuses.

The present invention is not limited to the above-described embodiments, and various modifications can be made. Such modifications are also included in the scope of the present invention as a matter of course.

### INDUSTRIAL APPLICABILITY

As described above, the information processing apparatus according to the present invention achieves the effect of determining an LPG price, using gas use information and climate information, and is useful as a server apparatus or the like.

1. An information processing apparatus comprising:
a gas information storage unit that stores two or more pieces of gas information that contain gas use information regarding two or more households; and
a climate information acceptance unit that accepts climate information that is associated with time information that specifies time;
a price information acquisition unit that acquires price information that specifies a price of LPG per unit amount at the time specified by the time information, using the gas use information regarding two or more households and the climate information; and
a price information output unit that outputs the price information acquired by the price information acquisition unit.

2. The information processing apparatus according to claim 1,
wherein the price information acquisition unit includes:
a demand prediction part that acquires a predicted demand amount that is the amount of future demand for LPG, using the gas use information regarding two or more households; and
a price information acquisition part that acquires price information regarding one or more days, using the predicted demand amount acquired by the demand prediction part and the climate information.

3. The information processing apparatus according to claim 1, further comprising
a related information storage unit that stores one or more pieces of related information of: gas price information regarding a gas price; exchange information regarding an exchange rate; and operation status information regarding an operation status of a gas tanker, and
the price information acquisition unit acquires price information regarding one or more days that are ahead by a predetermined period, using the gas use information for two or more households, the climate information, and the one or more pieces of related information.

4. The information processing apparatus according to claim 3,
wherein the price information acquisition unit
acquires price information that indicates a higher price as the price specified by the gas price information increases, or
acquires price information that indicates a higher price when exchange information indicates a higher yen compared to when exchange information indicates a lower yen, or
acquires price information that indicates a lower price when operation status information is information that indicates absence of a problem compared to when operation status information is information that indicates presence of any problem.

5. The information processing apparatus according to claim 1, further comprising:
a gas information reception unit that receives gas information from a gas information transmission apparatus that includes: a terminal acquisition unit that acquires gas information that is information that contains gas use information regarding use of gas in an LPG cylinder and corresponds to a customer identifier that identifies a customer; and a terminal transmission unit that transmits the gas information acquired by the terminal acquisition unit to the information processing apparatus; and
a gas information accumulation unit that accumulates the gas information received by the gas information reception unit, in the gas information storage unit, in association with the customer identifier.

6. A server apparatus comprising:
a server storage unit that stores the price information output by the information processing apparatus according to claim 1;
a server output unit that outputs the price information stored in the server storage unit;
a server reception unit that receives a purchase instruction that is a purchase instruction that corresponds to the price information output by the server output unit, and contains a user identifier and amount information that specifies an amount; and
a server processing unit that carries out futures trading processing through which a purchase reservation for the amount of LPG specified by the amount information at the price specified by the price information, according to the purchase instruction.

7. The server apparatus according to claim 6,
wherein the server processing unit includes:
a futures trading part that carries out futures trading processing through which a purchase reservation for the amount of LPG specified by the amount information is made at the price specified by the price information stored in the server storage unit, according to the purchase instruction;
a price changing part that, upon receiving the purchase instruction, acquires price information obtained by changing the price information stored in the server storage unit, and accumulates the price information in the server storage unit; and
the server output unit outputs the price information changed by the price information acquisition part.

8. An information processing method that is realized using: a gas information storage unit that stores two or more pieces of gas information that contain gas use information regarding two or more households; a climate information acceptance unit, a price information acquisition unit, and a price information output unit, the information processing method comprising:
a climate information acceptance step in which the climate information acceptance unit accepts climate information that is associated with time information that specifies time;
a price information acquisition step in which the price information acquisition unit acquires price information that specifies a price of LPG per unit amount at the time specified by the time information, using the gas use information regarding two or more households and the climate information; and
a price information output step in which the price information output unit outputs the price information acquired by the price information acquisition unit.

9. A non-transitory computer readable medium storing a program for enabling a computer that can access a gas information storage unit that stores two or more pieces of gas information that contains gas use information regarding two or more households to function as:
a climate information acceptance unit that accepts climate information that is associated with time information that specifies time;
a price information acquisition unit that acquires price information that specifies a price of LPG per unit amount at the time specified by the time information, using the gas use information regarding two or more households and the climate information; and
a price information output unit that outputs the price information acquired by the price information acquisition unit.
